(19) United States
(12) Patent Application Publication
(10) Pub. No.: US 2025/0260763 A1
(43) Pub. Date: Aug. 14, 2025

(54) Information Processing Method and Information Processing System

(71) Applicant: Dongriii Co., Ltd., Kusatsu-shi (JP)

(72) Inventors: Taihei Fujii, Otsu-shi (JP); Shisei Kan, Hiroshima-shi (JP)

(21) Appl. No.: 19/020,424

(22) Filed: Jan. 14, 2025

Related U.S. Application Data
(60) Provisional application No. 63/551,211, filed on Feb. 8, 2024.

(30) Foreign Application Priority Data
May 2, 2024 (JP) 2024-074830

(51) Int. Cl. H04M 1/72424; G06V 10/774; G06V 20/40; H04L 65/1069; H04L 65/1089; H04M 1/72436; H04M 1/72457; H04M 1/72484

(52) U.S. Cl. CPC H04M 1/72424; G06V 10/774; G06V 20/41; H04L 65/1069; H04L 65/1089; H04M 1/72436; H04M 1/72457; H04M 1/72484; H04M 2201/405

(57) ABSTRACT

Provided are an information processing method and the like capable of displaying an alert notification according to a nurse call of a patient received by a smart phone of the patient to a smart phone of a nurse.

An information processing method according to one aspect is letterized in that a nurse call object is displayed on a first display unit of a smart phone of each patient, and when a manipulation of the nurse call object is received, an alert notification including identification information for identifying a patient who has performed the manipulation is displayed on a second display unit of a smart phone of a nurse.

### CROSS-REFERENCE TO RELATED APPLICATIONS

This non-provisional application claims priority under 35 U.S.C. § 119 (a) on Patent Application No. 2024-074830 filed in Japan on May 2, 2024 and U.S. Provisional Patent Application No. 63/551,211 filed in Feb. 8, 2024, the entire contents of which are hereby incorporated by reference.

Recently, in a facility such as a hospital, there has been active development of a technology relevant to a nurse call system for a patient to call a nurse. For example, in Japanese Patent Laid-Open Publication No. 2007-124312, a nurse call system is disclosed in which a mobile terminal for a patient is set and registered to correspond to a specific nurse call extension unit line, and a call manipulation is performed in a nurse call extension unit of the line or in the mobile terminal for a patient to call a nurse call base unit and a mobile terminal for a staff and talk to a person who answers first.

### DESCRIPTION

However, the invention according to Japanese Patent Laid-Open Publication No. 2007-124312 has a problem that dedicated nurse call base unit and nurse call extension unit are separately prepared.

In one aspect, provided are an information processing method and the like capable of displaying an alert notification according to a nurse call of a patient received by a smart phone of the patient on a smart phone of the nurse.

An information processing method according to one aspect is letterized by executing processing of displaying a nurse call object on a first display unit of a smart phone of each patient, and displaying, when a manipulation of the nurse call object is received, an alert notification including identification information for identifying a patient who has performed the manipulation on a second display unit of a smart phone of a nurse.

In one aspect, it is possible to display the alert notification according to the nurse call of the patient received by the smart phone of the patient on the smart phone of the nurse.

The above and further objects and features will more fully be apparent from the following detailed description with accompanying drawings.

### BRIEF DESCRIPTION OF DRAWINGS

FIG. 1 is an explanatory diagram illustrating an outline of a nurse call system.

FIG. 2 is a block diagram illustrating a configuration example of a server.

FIG. 3 is an explanatory diagram illustrating an example of a record layout of a patient DB and a nurse DB.

FIG. 4 is an explanatory diagram illustrating an example of a record layout of an alert setting DB and an alert notification management DB.

FIG. 5 is a block diagram illustrating a configuration example of a patient smart phone and a nurse smart phone.

FIG. 6A is an explanatory diagram illustrating an example of a reception screen of a nurse call.

FIG. 6B is an explanatory diagram illustrating an example of a reception screen of a nurse call.

FIG. 6C is an explanatory diagram illustrating an example of a reception screen of a nurse call.

FIG. 7 is an explanatory diagram illustrating an example of a display screen of an alert notification.

FIG. 8 is a flowchart illustrating a processing procedure when a nurse call is received.

FIG. 9 is a flowchart illustrating a processing procedure when an alert notification is displayed.

FIG. 10 is a flowchart illustrating a processing procedure when an unresponded alert is periodically notified.

FIG. 11 is an explanatory diagram illustrating an example of a record layout of an alert setting DB in Modification Example 1.

FIG. 12A is an explanatory diagram illustrating an example of a reception screen and a display screen in Modification Example 1.

FIG. 12B is an explanatory diagram illustrating an example of a reception screen and a display screen in Modification Example 1.

FIG. 13 is a flowchart illustrating a processing procedure when a nurse call is received in Modification Example 1.

FIG. 14 is an explanatory diagram illustrating an example of a display screen of an alert notification in Modification Example 2.

FIG. 15 is a flowchart illustrating a processing procedure when a sound or a text is simultaneously notified.

FIG. 16 is a block diagram illustrating a configuration example of a server in Embodiment 2.

FIG. 17 is an explanatory diagram illustrating an example of a screen of a video call.

FIG. 18 is a flowchart illustrating a processing procedure when a video call between a patient and a nurse is established.

FIG. 19 is an explanatory diagram illustrating an example of a record layout of a nurse DB in Embodiment 3.

FIG. 20 is an explanatory diagram illustrating an example of a display screen of an evaluation of each nurse.

FIG. 21 is a flowchart illustrating a processing procedure when an evaluation of each nurse is output.

FIG. 22A is a schematic view illustrating an appearance of a nurse call button or an emergency nurse call button.

FIG. 22B is a schematic view illustrating an appearance of a nurse call button or an emergency nurse call button.

FIG. 22C is a schematic view illustrating an appearance of a nurse call button or an emergency nurse call button.

FIG. 23 is a flowchart illustrating a processing procedure when an alert notification is transmitted to a nurse smart phone in a case where a button is manipulated.

FIG. 24 is a block diagram illustrating a configuration example of a server in Embodiment 5.

FIG. 25 is an explanatory diagram illustrating output processing of a report document by a report document output model.

FIG. 26 is a flowchart illustrating a processing procedure when a report document with respect to an alert notification is displayed.

Hereinafter, the present invention will be described in detail on the basis of the drawings illustrating embodiments thereof.

### EMBODIMENT 1

Embodiment 1 relates to a form in which an alert notification according to a nurse call of a patient received by a smart phone of the patient is displayed on a smart phone of a nurse.

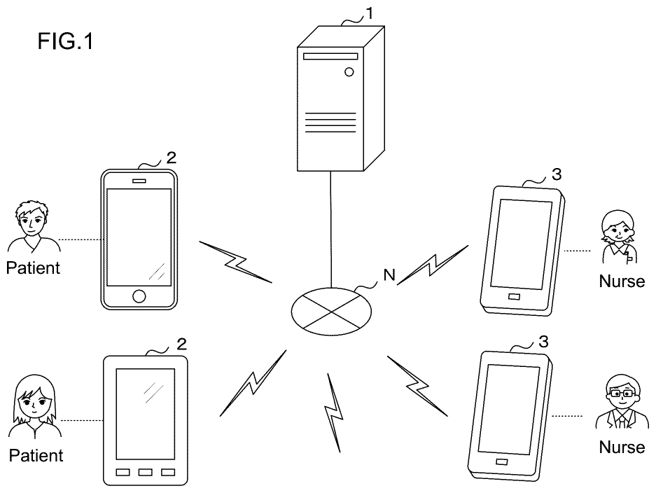

FIG. 1 is an explanatory diagram illustrating the outline of a nurse call system. The system of this embodiment includes an information processing device 1, a plurality of information processing terminals 2, and a plurality of information processing terminals 3, and each device performs information transmission/reception through a network N such as the Internet.

The information processing device 1 is an information processing device performing processing, storage, and transmission/reception on various types of information. The information processing device 1, for example, is a server device, a personal computer, or the like. In this embodiment, hereinafter, for the purposes of brevity, the information processing device 1 will be replaced with a server 1.

The information processing terminal 2 is a terminal device for a patient performing reception, transmission, and the like on a nurse call. The information processing terminal 2, for example, is an information processing device such as a smart phone, a mobile phone, a wearable device such as a smart watch, a tablet, or a personal computer terminal. Hereinafter, for the purposes of brevity, the information processing terminal 2 will be replaced with a patient smart phone 2.

The information processing terminal 3 is a terminal device for a nurse performing reception, display, and the like on the alert notification according to the nurse call of the patient. The information processing terminal 3, for example, is an information processing device such as a smart phone, a mobile phone, a wearable device such as a smart watch, a tablet, or a personal computer terminal. Hereinafter, for the purposes of brevity, the information processing terminal 3 will be replaced with a nurse smart phone 3.

In general, in the clinical environment, there are various alert sounds. Since there is a possibility that medical accidents occur due to a distinction error in similar sounds, it is necessary for the nurse to check all the alert sounds. In order to solve such a problem, in this embodiment, the alert notification according to the nurse call of each patient is displayed on the nurse smart phone 3.

Each of the patient smart phones 2 according to this embodiment displays a nurse call object on a first display unit. In a case where the manipulation of the nurse call object is received, each of the patient smart phones 2 transmits identification information for identifying the patient who has performed the manipulation to the server 1. The server 1 receives the identification information transmitted from each of the patient smart phones 2. The server 1 transmits the alert notification including the received identification information to the nurse smart phone 3. The nurse smart phone 3 receives the alert notification transmitted from the server 1. The nurse smart phone 3 displays the received alert notification on the second display unit.

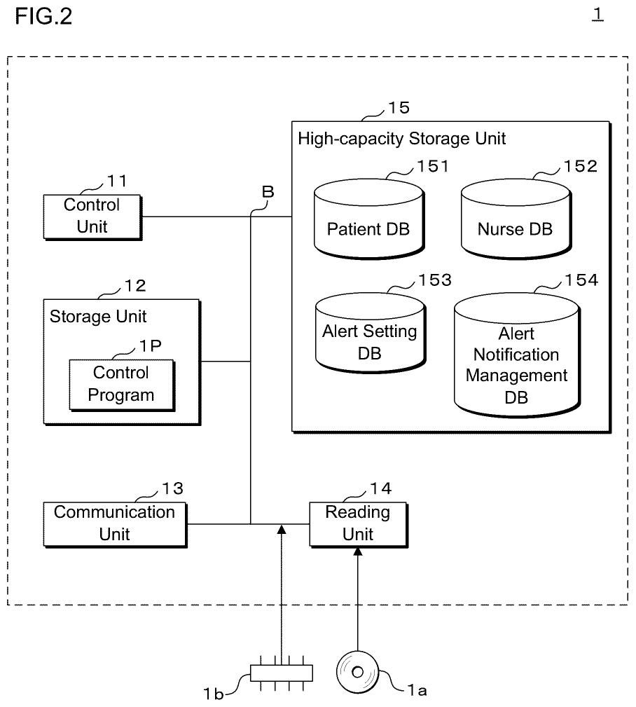

FIG. 2 is a block diagram illustrating a configuration example of the server 1. The server 1 includes a control unit 11, a storage unit 12, a communication unit 13, a reading unit 14, and a high-capacity storage unit 15. Each constituent is connected by a bus B.

The control unit 11 includes an arithmetic processing device such as a central processing unit (CPU), a micro-processing unit (MPU), a graphics processing unit (GPU), a field programmable gate array (FPGA), a digital signal processor (DSP), or a quantum processor. The control unit 11 reads out and executes a control program 1P (a program product) stored in the storage unit 12 to perform various types of information processing, control processing, or the like according to the server 1.

Note that the control program 1P can be decompressed to be executed on a single computer, or on a plurality of computers that are disposed in one site or distributed over a plurality of sites and connected to each other through a communication network.

Note that in FIG. 2, the control unit 11 is illustrated as a single processor, but may be a multi-processor. Note that the control unit 11 may execute various types of information processing, control processing, or the like by the same processor in the server 1, or by different processors in the server 1.

The storage unit 12 includes a memory element such as a random access memory (RAM) and a read only memory (ROM), and stores the control program 1P, data, or the like required for the control unit 11 to execute processing. In addition, the storage unit 12 temporarily stores data or the like required for the control unit 11 to execute arithmetic processing. The communication unit 13 is a communication module for performing processing relevant to communication, and performs information transmission/reception with respect to the patient smart phone 2, the nurse smart phone 3, or the like through the network N.

The reading unit 14 reads a portable storage medium 1a including a compact disc (CD)-ROM or a digital versatile disc (DVD)-ROM. The control unit 11 may read the control program 1P from the portable storage medium 1a through the reading unit 14, and store the control program in the high-capacity storage unit 15. In addition, the control unit 11 may download the control program 1P from other computers through the network N or the like, and store the control program in the high-capacity storage unit 15. In addition, the control unit 11 may read in the control program 1P from a semiconductor memory 1b.

The high-capacity storage unit 15, for example, includes a recording medium such as a hard disk drive (HDD) or a solid state drive (SSD). The high-capacity storage unit 15 includes a patient database (DB) 151, a nurse DB 152, an alert setting DB 153, and an alert notification management DB 154.

In the patient DB 151, information relevant to the patient is stored. In the nurse DB 152, information relevant to the nurse is stored. In the alert setting DB 153, setting information including the type of alert notification, an emergency degree, or the like is stored. In the alert notification management DB 154, management information of the alert notification (a notification date and time, a response status, and the like) is stored.

Note that in this embodiment, the storage unit 12 and the high-capacity storage unit 15 may be configured as an integrated storage device. In addition, the high-capacity storage unit 15 may be configured by a plurality of storage devices. In addition, the high-capacity storage unit 15 may be an external storage device connected to the server 1.

The server 1 may cause a single computer to execute various types of information processing, control processing, and the like, or may cause a plurality of computers to execute the processing in a distributed manner. In addition, the server 1 may be attained by a plurality of virtual machines provided in one server, or may be attained by using a cloud server.

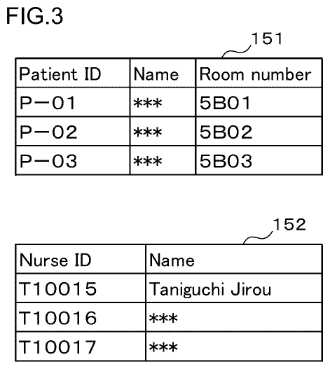

FIG. 3 is an explanatory diagram illustrating an example of the record layout of the patient DB 151 and the nurse DB 152.

The patient DB 151 includes a patient ID column, a name column, and a room number column. In the patient ID column, the patient ID of the patient that is uniquely specified in order to identify each patient is stored. Note that the patient ID may be the patient registration card number of the patient. In the name column, the name of the patient is stored. In the room number column, the room number of the patient is stored. Note that in the patient DB 151, information such as the age and the gender of the patient, the name of the attending doctor, the medical department, or whether to use a wheelchair may be stored.

The nurse DB 152 includes a nurse ID column and a name column. In the nurse ID column, the nurse ID of the nurse that is uniquely specified in order to identify each nurse is stored. In the name column, the name of the nurse is stored.

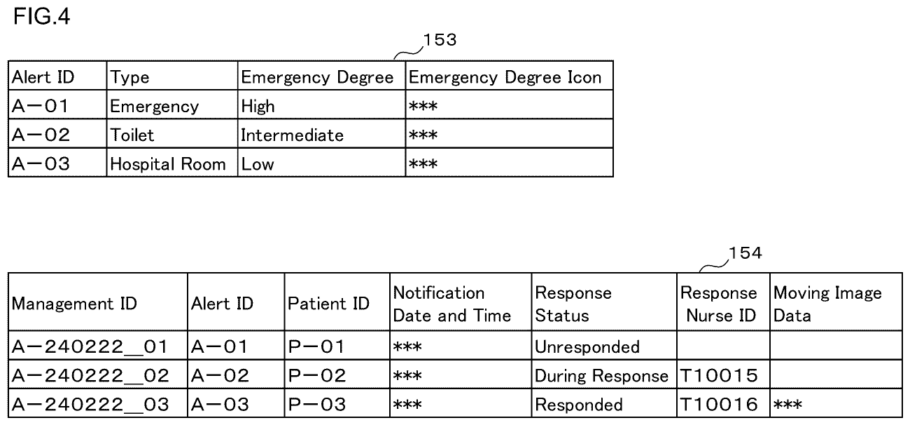

FIG. 4 is an explanatory diagram illustrating an example of the record layout of the alert setting DB 153 and the alert notification management DB 154.

The alert setting DB 153 includes an alert ID column, a type column, an emergency degree column, and an emergency degree icon column. In the alert ID column, the alert ID of the alert that is uniquely specified in order to identify each alert is stored. In the type column, the type of alert notification is stored. The type of alert notification, for example, includes “emergency”, “toilet”, “hospital room”, or the like.

In the emergency degree column, an emergency degree indicating the level of alert response priority is stored. The emergency degree, for example, may be classified into “high”, “intermediate”, and “low”, in accordance with the type of alert notification. In the emergency degree icon column, an icon indicating the emergency degree is stored.

The alert notification management DB 154 includes a management ID column, an alert ID column, a patient ID column, a notification date and time column, a response status column, a response nurse ID column, and a moving image data column.

In the management ID column, the management ID of management data of the alert notification that is uniquely specified in order to identify the management data of each alert notification is stored. In the alert ID column, the alert ID for specifying the alert is stored. In the patient ID column, the patient ID for specifying the patient is stored. In the notification date and time column, date and time information when the alert is notified is stored.

In the response status column, the response status of the alert notification is stored. The response status, for example, includes “unresponded”, “during response”, “responded”, or the like. In the response nurse ID column, in a case where the response status is “during response” or “responded”, the nurse ID of the nurse who responds to the alert notification is stored. In the moving image data column, moving image data in a video call between the patient corresponding to the alert notification and the nurse is stored.

Note that the storage format of each DB described above is an example, and may be other storage formats insofar as a relationship between the data pieces is maintained.

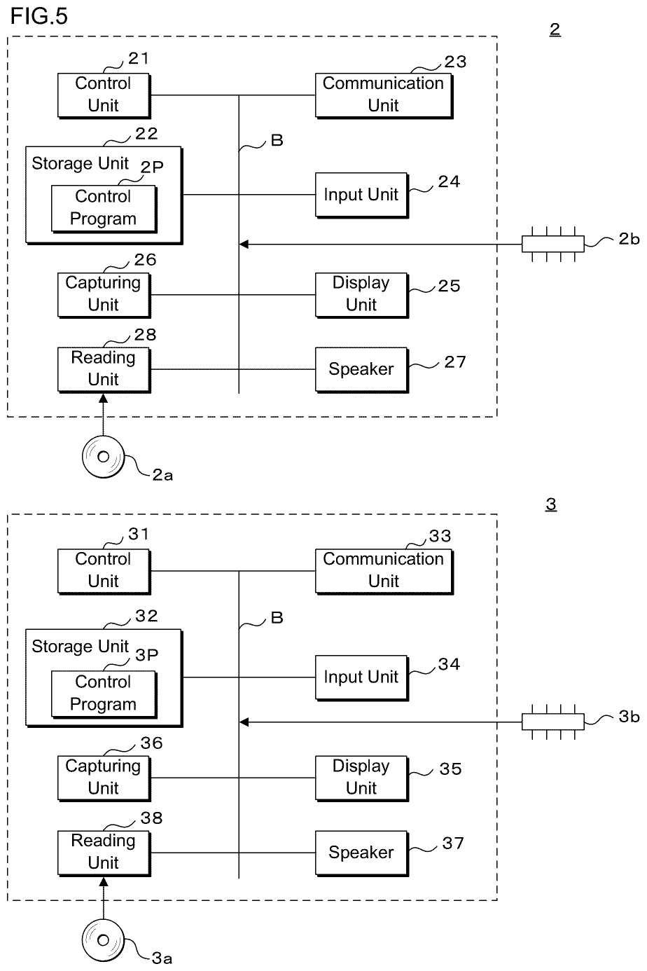

FIG. 5 is a block diagram illustrating a configuration example of the patient smart phone 2 and the nurse smart phone 3.

The patient smart phone 2 includes a control unit 21, a storage unit 22, a communication unit 23, an input unit 24, a display unit 25 (a first display unit), a capturing unit 26, a speaker 27, and a reading unit 28. Each constituent is connected by the bus B.

The control unit 21 includes an arithmetic processing device such as a CPU or a MPU, and reads out and executes a control program 2P (a program product) stored in the storage unit 22 to perform various types of information processing, control processing, and the like according to the patient smart phone 2.

Note that in FIG. 5, the control unit 21 is illustrated as a single processor, but may be a multi-processor. Note that the control unit 21 may execute various types of information processing, control processing, or the like by the same processor in the patient smart phone 2, or by different processors in the patient smart phone 2.

The storage unit 22 includes a memory element such as a RAM and a ROM, and stores the control program 2P, data, or the like required for the control unit 21 to execute processing. In addition, the storage unit 22 temporarily stores data or the like required for the control unit 21 to execute arithmetic processing.

The communication unit 23 is a communication module for performing processing related to communication, and performs information transmission/reception with respect to the server 1 or the like through the network N. The input unit 24 may be a keyboard, a mouse, or a touch panel integrated with the display unit 25. The display unit 25 is a liquid crystal display, an organic electroluminescence (EL) display, or the like, and displays various types of information in accordance with an instruction from the control unit 21.

The capturing unit 26, for example, is a capturing device such as a charge coupled device (CCD) camera or a complementary metal oxide semiconductor (CMOS) camera. Note that the capturing unit 26 may not be embedded in the patient smart phone 2, but may be externally connected directly to the patient smart phone 2 such that capturing is available. The speaker 27 is a device converting an electrical signal into a sound.

The reading unit 28 reads a portable storage medium 2a including a CD-ROM or a DVD-ROM. The control unit 21 may read the control program 2P from the portable storage medium 2a through the reading unit 28, and store the control program in the storage unit 22. In addition, the control unit 21 may download the control program 2P from other computers through the network N or the like, and store the control program in the storage unit 22. In addition, the control unit 21 may read in the control program 2P from the semiconductor memory 2b.

The nurse smart phone 3 includes a control unit 31, a storage unit 32, a communication unit 33, an input unit 34, a display unit 35 (a second display unit), a capturing unit 36, a speaker 37, and a reading unit 38. Each constituent is connected by the bus B. Note that since the configuration of the nurse smart phone 3 is the same as the configuration of the patient smart phone 2, the description will be omitted.

Subsequently, the operation of the nurse call system will be described. First, nurse call reception processing by the patient smart phone 2 will be described.

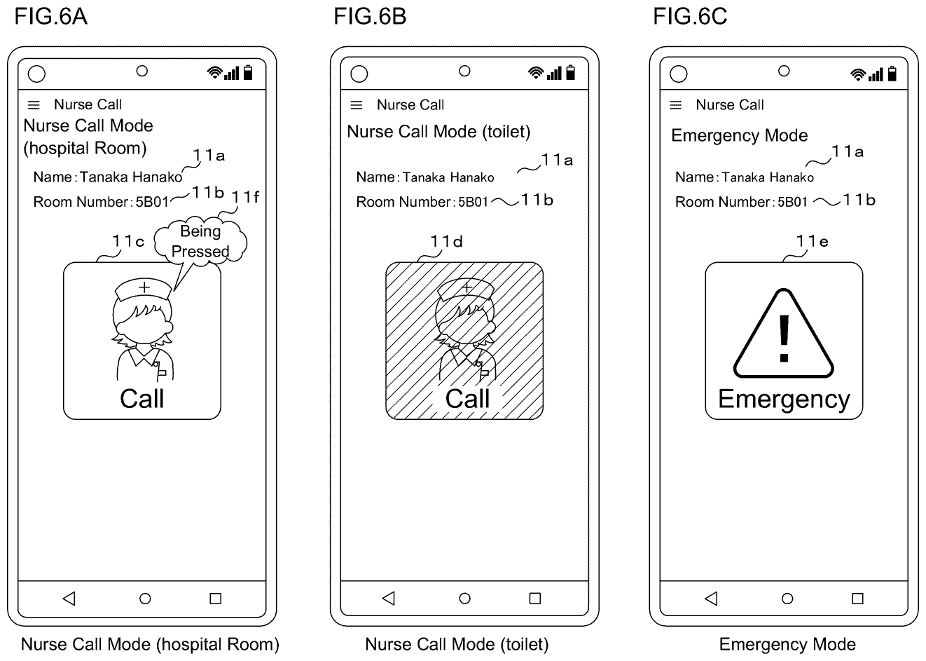

FIG. 6A, FIG. 6B and FIG. 6C are explanatory diagrams illustrating an example of a reception screen of the nurse call. In this system, a nurse call mode according to a place including a hospital room or a toilet, and an emergency mode are provided. The patient smart phone 2 displays a mode selection screen (not illustrated) for receiving the selection of a hospital room nurse call mode, a toilet nurse call mode, or an emergency mode.

In a case where a switching manipulation in the hospital room nurse call mode, the toilet nurse call mode, and the emergency mode is received through the mode selection screen, the patient smart phone 2 displays the hospital room nurse call mode, the toilet nurse call mode, and the emergency mode by switching on the display unit 25. For example, in a case where the touch manipulation of a switching button on the mode selection screen is received, the patient smart phone 2 displays the hospital room nurse call mode, the toilet nurse call mode, and the emergency mode by switching on the display unit 25.

FIG. 6A is an explanatory diagram illustrating an example of a reception screen in the nurse call mode (the hospital room). FIG. 6B is an explanatory diagram illustrating an example of a reception screen in the nurse call mode (the toilet). FIG. 6C is an explanatory diagram illustrating an example of a reception screen in the emergency mode.

The reception screen includes a patient name display section 11a, a room number display section 11b, a hospital room nurse call icon 11c, a toilet nurse call icon 11d, an emergency call icon 11e, and a balloon icon 11f.

The patient name display section 11a is a display section for displaying the name of the patient. The room number display section 11b is a display section for displaying the room number of the patient. In a case where the manipulation (for example, a touch or a double-click) of the hospital room nurse call icon 11c, the toilet nurse call icon 11d, or the emergency call icon 11e is received, the balloon icon 11f is an icon indicating a state where the manipulation is received.

In the nurse call mode, the patient smart phone 2 displays the nurse call object (the hospital room nurse call icon 11c or the toilet nurse call icon 11d) on the display unit 25. The hospital room nurse call icon 11c is an icon for receiving the nurse call from the hospital room. The toilet nurse call icon 11d is an icon for receiving the nurse call from the toilet.

In the emergency mode, the patient smart phone 2 displays an emergency call object (the emergency call icon 11e) on the display unit 25. The emergency call icon 11e is an icon for receiving the nurse call in emergency.

Note that the display format of the hospital room nurse call icon 11c, the toilet nurse call icon 11d, and the emergency call icon 11e is not limited to the icon, and for example, may be an object such as a button or an image.

The patient smart phone 2 transmits the patient ID to the server 1. The server 1 acquires the name and the room number of the patient from the patient DB 151, on the basis of the patient ID transmitted from the patient smart phone 2. Note that in a case where this system cooperates with an external electronic medical record system or the like, the server 1 may acquire the name and the room number of the patient from the electronic medical record system, on the basis of the patient ID.

Note that in a case where the name and the room number of the patient are not stored (registered) in the patient DB 151, the patient smart phone 2 transmits patient information including the patient ID, the name, the room number, and the like to the server 1. The server 1 stores the patient information transmitted from the patient smart phone 2 in the patient DB 151.

The server 1 transmits the acquired name and room number of the patient to the patient smart phone 2. The patient smart phone 2 displays the name of the patient transmitted from the server 1 in the patient name display section 11a, and displays the room number in the room number display section 11b.

As illustrated in FIG. 6A, in a case where the touch (click) manipulation of the hospital room nurse call icon 11c is received in the nurse call mode in the hospital room, the patient smart phone 2 transmits the identification information (for example, the name and the room number of the patient) for identifying the patient who has performed the manipulation, and the type of alert notification, which is “hospital room”, to the server 1.

As illustrated in FIG. 6B, in a case where the touch manipulation of the toilet nurse call icon 11d is received in the nurse call mode in the toilet, the patient smart phone 2 transmits the identification information of the patient who has performed the manipulation, and the type of alert notification, which is “toilet”, to the server 1.

As illustrated in FIG. 6C, in a case where the touch manipulation of the emergency call icon 11e is received in the emergency mode, the patient smart phone 2 transmits the identification information of the patient who has performed the manipulation, and the type of alert notification, which is “emergency”, to the server 1.

In addition, in a case where the touch manipulation of any of the hospital room nurse call icon 11c, the toilet nurse call icon 11d, and the emergency call icon 11e is received, the patient smart phone 2 displays the balloon icon 11f, in association with the corresponding call icon. As illustrated, the balloon icon 11f indicates a state where the touch manipulation of the hospital room nurse call icon 11c is received, in the letter “being pressed”.

Note that the letter displayed in the balloon icon 11f is any letter, and in addition to the letter, an illustration or the like may be used. Note that not only the balloon icon, for example, but also any of the hospital room nurse call icon 11c, the toilet nurse call icon 11d, and the emergency call icon 11e are pressed, the color or the size of the corresponding call icon may be changed. Alternatively, in a case where any of the hospital room nurse call icon 11c, the toilet nurse call icon 11d, and the emergency call icon 11e are pressed, the display format may be changed such that the corresponding call icon is shown as being pressed.

The server 1 receives the identification information of the patient and the type of alert notification, which are transmitted from the patient smart phone 2. The server 1 transmits the alert notification including the identification information and the type of alert notification, which are transmitted from each of the patient smart phones 2, to the nurse smart phone 3. The nurse smart phone 3 receives a plurality of alert notifications of patients with different identification information transmitted from the server 1. The nurse smart phone 3 displays the plurality of received alert notifications on the display unit 35.

Next, alert notification display processing by the nurse smart phone 3 will be described.

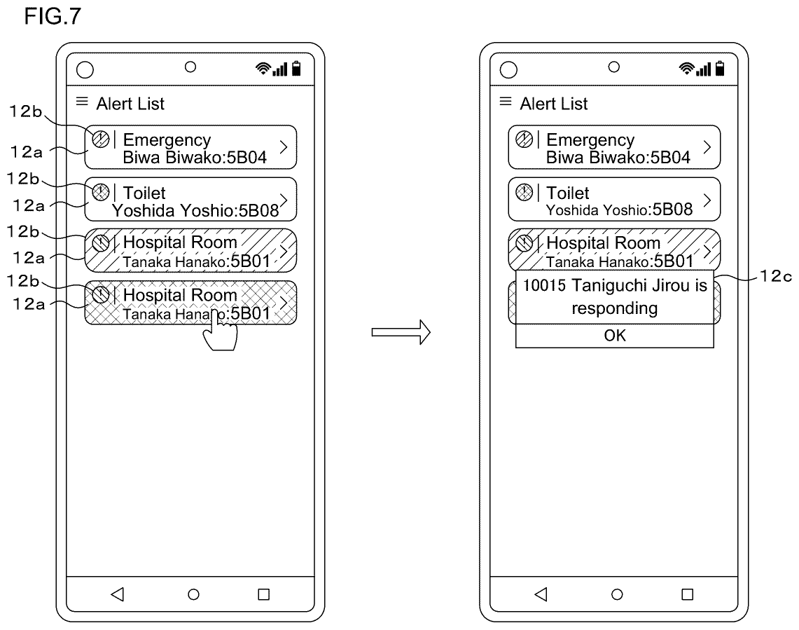

FIG. 7 is an explanatory diagram illustrating an example of a display screen of the alert notification. The display screen includes a plurality of alert notification display sections 12a and emergency degree icons 12b, and a message dialogue 12c. The alert notification display section 12a is a display section for displaying the alert notification. The emergency degree icon 12b is an icon indicating the emergency degree of the alert notification. The message dialogue 12c is a message dialogue for displaying a notification to the nurse.

The server 1 acquires the alert ID from the alert setting DB 153, in accordance with the type of alert notification transmitted from the patient smart phone 2. The server 1 acquires the corresponding patient ID from the patient DB 151, on the basis of the identification information of the patient. The server 1 stores the alert notification of the patient in the alert notification management DB 154. Specifically, the server 1 assigns the management ID. The server 1 stores the acquired alert ID and patient ID, the date and time when the alert is notified, and the response status, which is “unresponded”, as one record, in the alert notification management DB 154, in association with the assigned management ID.

The server 1 generates alert notification display information for displaying the plurality of alert notifications of the patients with different identification information. Specifically, the server 1 acquires, for each patient, the alert ID, the patient ID, the response status, and the response nurse ID from the alert notification management DB 154, on the basis of the response status, which is “unresponded” or “during response”. The server 1 acquires the identification information of the patient including the name or the room number of the patient from the patient DB 151, on the basis of each patient ID. The server 1 acquires the type of alert notification, the emergency degree, and the emergency degree icon from the alert setting DB 153, on the basis of the alert ID corresponding to each patient. The server 1 generates the alert notification display information including each patient's the identification information, the type of alert notification, the emergency degree, the emergency degree icon, or the like, which is acquired.

The server 1 transmits the generated alert notification display information to the nurse smart phone 3. The nurse smart phone 3 receives the alert notification display information transmitted from the server 1. The nurse smart phone 3 displays the received alert notification display information in the alert notification display section 12a in a predetermined display order. The display order, for example, may be a descending order of the emergency degree, or may be a reverse chronological order of the notification date and time.

As illustrated, in the alert notification display section 12a, the type of alert notification, and the name and the room number of the patient are displayed. Note that the information displayed in the alert notification display section 12a described above is merely an example, and is not limited to the type of alert notification, and the name and the room number of the patient. For example, in a case where the information such as the age of the patient, the gender of the patient, the name of the attending doctor, the medical department, or whether to use a wheelchair is transmitted to the nurse smart phone 3 by the server 1, the nurse smart phone 3 may display such information in the alert notification display section 12a.

In addition, the nurse smart phone 3 displays the emergency degree icon included in the alert notification display information in the emergency degree icon 12b, in association with each alert notification display section 12a. As illustrated, an icon with a high emergency degree is indicated with diagonally right up hatching, an icon with an intermediate emergency degree is indicated with cross-hatching, and an icon with a low emergency degree is indicated with diagonally right down hatching. Note that the icon is not limited to the display mode described above. The display mode may be obtained by changing a figure or a design drawn in the emergency degree icon 12b, or may be obtained by changing a color, a pattern, or the like.

For example, in a case where the alert notification is not responded, the display mode of the alert notification display section 12a is not indicated with hatching.

In a case where the touch manipulation of the alert notification to be a response target is received, the nurse smart phone 3 changes the display mode of the alert notification to indicate to which alert notification the nurse is responding. As illustrated, the display mode of the alert notification display section 12a corresponding to the alert notification during response by the nurse (a first nurse) is indicated with diagonally right up hatching.

In this case, the nurse smart phone 3 updates the response status of the alert notification. Specifically, the nurse smart phone 3 transmits the management ID corresponding to the alert notification and the nurse ID of the nurse to the server 1. The server 1 stores the response status, which is “during response”, and the nurse ID during response in the alert notification management DB 154, in association with the management ID transmitted from the nurse smart phone 3.

In addition, in the plurality of alert notifications displayed in the alert notification display section 12a, the nurse smart phone 3 changes the display mode of the alert notification during response by a second nurse different from the first nurse. As illustrated, the display mode of the alert notification display section 12a corresponding to the alert notification during response by the second nurse is indicated with cross-hatching.

Note that the alert notification display section 12a is not limited to the display mode described above. The display mode may be obtained by changing a figure or a design drawn in the alert notification display section 12a, or may be obtained by changing a color, a pattern, or the like.

In a case where the touch manipulation of the alert notification during response by the second nurse is received, the nurse smart phone 3 transmits the identification information of the patient corresponding to the alert notification to the server 1. The server 1 receives the identification information of the patient transmitted from the nurse smart phone 3. The server 1 acquires information relevant to the second nurse, on the basis of the received identification information. The information relevant to the second nurse, for example, includes the nurse ID (hereinafter, will be replaced with a second nurse ID), the name, and the like of the second nurse.

Specifically, the server 1 acquires the second nurse ID from the alert notification management DB 154, on the basis of the received identification information. The server 1 acquires the name of the second nurse from the nurse DB 152, on the basis of the acquired second nurse ID. The server 1 transmits the acquired second nurse ID and name to the nurse smart phone 3.

Note that in a case where the information relevant to the second nurse during response is included in the alert notification transmitted to the nurse smart phone 3, the nurse smart phone 3 may acquire the second nurse ID, the name, and the like from the alert notification.

The nurse smart phone 3 receives the second nurse ID and the name transmitted from the server 1. The nurse smart phone 3 displays a message including the received second nurse ID and name in the message dialogue 12c. As illustrated, as an example, “10015 Taniguchi Jirou is responding” is displayed in the message dialogue 12c.

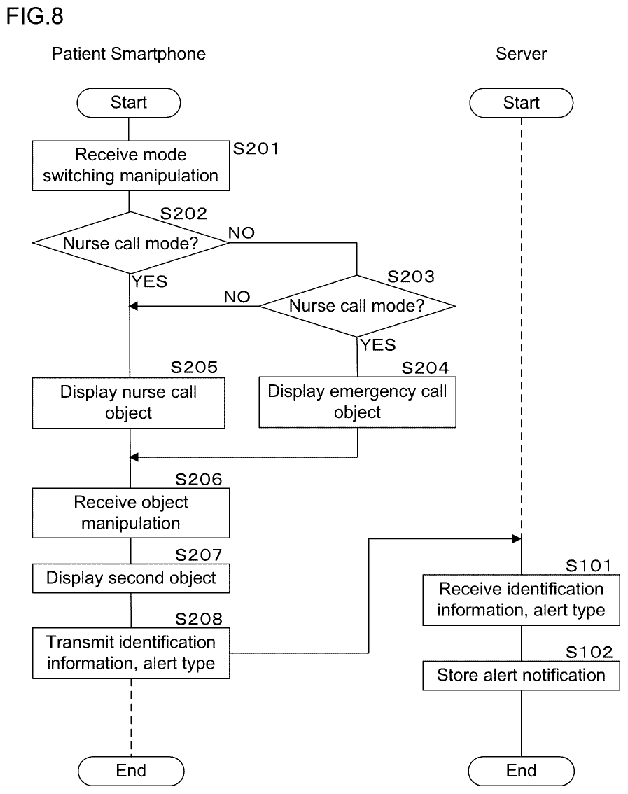

FIG. 8 is a flowchart illustrating a processing procedure when the nurse call is received. The control unit 21 of the patient smart phone 2 receives a switching manipulation between the nurse call mode (for example, the nurse call mode in the hospital room or the nurse call mode in the toilet) and the emergency mode by the input unit 24 (step S201). The control unit 21 determines whether the mode is the nurse call mode by the switching manipulation (step S202).

In a case where it is determined that the mode is not the nurse call mode (NO in step S202), the control unit 21 determines whether the mode is the emergency mode by the switching manipulation (step S203). In a case where it is determined that the mode is not the emergency mode (NO in step S203), the control unit 21 transitions to the processing of step S205 described below.

In a case where it is determined that the mode is the emergency mode (YES in step S203), the control unit 21 displays the emergency call object (for example, the emergency call icon 11e in FIG. 6C) by the display unit 25 (step S204). The control unit 21 transitions to the processing of step S206 described below.

In a case where it is determined that the mode is the nurse call mode (YES in step S202), the control unit 21 displays the nurse call object (for example, the hospital room nurse call icon 11c in FIG. 6A or the toilet nurse call icon 11d in FIG. 6B) by the display unit 25 (step S205).

The control unit 21 receives the manipulation (for example, the touch) of the nurse call object or the emergency call object by the input unit 24 (step S206). The control unit 21 displays a second object (for example, the balloon icon 11f in FIG. 6A) indicating a state where the manipulation is received through the display unit 25, in association with the nurse call object or the emergency call object (step S207).

The control unit 21 transmits the identification information (for example, the patient ID, and the name and the room number of the patient) for identifying the patient who has performed the manipulation, and the type of alert notification (for example, the hospital room, the toilet, or the emergency) to the server 1 by the communication unit 13 (step S208). The control unit 11 of the server 1 receives the identification information of the patient and the type of alert notification, which are transmitted from the patient smart phone 2, by the communication unit 13 (step S101).

The control unit 11 stores the alert notification in the alert notification management DB 154 of the high-capacity storage unit 15 (step S102). Specifically, the control unit 11 acquires the corresponding alert ID from the alert setting DB 153 of the high-capacity storage unit 15, on the basis of the type of received alert notification. The control unit 11 assigns the management ID. The control unit 11 stores the acquired alert ID and patient ID, the date and time when the alert is notified, and the response status, which is “unresponded”, as one record, in the alert notification management DB 154, in association with the assigned management ID. The control unit 11 ends the processing.

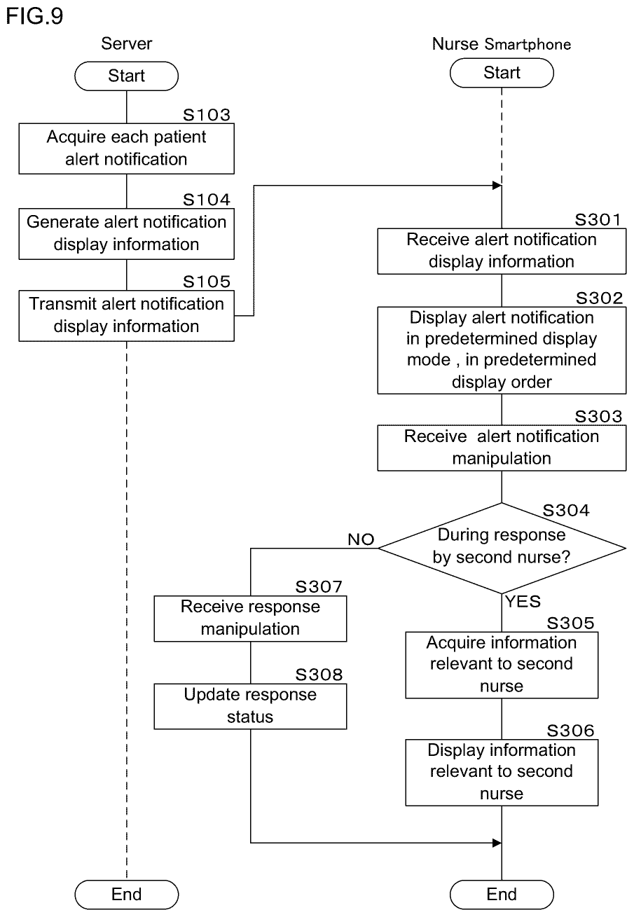

FIG. 9 is a flowchart illustrating a processing procedure when the alert notification is displayed. The control unit 11 of the server 1 acquires the alert notification for each patient from the alert notification management DB 154 of the high-capacity storage unit 15 (step S103). Specifically, the control unit 11, for each patient, acquires the alert ID, the patient ID, the response status, and the response nurse ID from the alert notification management DB 154, on the basis of the response status, which is “unresponded” or “during response”.

The control unit 11 generates the alert notification display information for displaying the plurality of alert notifications of the patients with different identification information (step S104). Specifically, the control unit 11 acquires the identification information of the patient including the name or the room number of the patient from the patient DB 151 of the high-capacity storage unit 15, on the basis of each patient ID. The control unit 11 acquires the type of alert notification, the emergency degree, and the emergency degree icon from the alert setting DB 153 of the high-capacity storage unit 15, on the basis of the alert ID corresponding to each patient. The control unit 11 generates the alert notification display information including the acquired identification information, the type of alert notification, the emergency degree, the emergency degree icon, or the like, for each patient.

The control unit 11 transmits the generated alert notification display information to the nurse smart phone 3 by the communication unit 13 (step S105). The control unit 31 of the nurse smart phone 3 receives the alert notification display information transmitted from the server 1 by the communication unit 33 (step S301). The control unit 31 displays the received alert notification display information in a predetermined display mode through the display unit 35, in a predetermined display order (for example, the descending order of the emergency degree or the reverse chronological order of the notification date and time) (step S302).

For the display mode, for example, the control unit 31 displays the alert notification of which the response status is “unresponded” without hatching. Alternatively, in a case where the response status is “during response”, and the response nurse ID is the nurse ID of the nurse (the first nurse), the control unit 31 displays the alert notification with diagonally right up hatching. In addition, in a case where the response status is “during response”, and the response nurse ID is the second nurse ID different from the first nurse, the control unit 31 displays the alert notification with cross-hatching.

The control unit 31 receives the manipulation (for example, the touch) of the alert notification by the input unit 34 (step S303). The control unit 31 determines whether the alert notification corresponding to the received manipulation is the alert notification during response by the second nurse (step S304). In a case where the alert notification corresponding to the received manipulation is the alert notification during response by the second nurse (YES in step S304), the control unit 31 acquires the information relevant to the second nurse (the second nurse ID, the name, and the like) (step S305).

Specifically, the control unit 31 transmits identification information of the patient corresponding to the alert notification to the server 1. The control unit 11 of the server 1 receives the identification information of the patient transmitted from the nurse smart phone 3. The control unit 11 acquires the second nurse ID from the alert notification management DB 154 of the high-capacity storage unit 15, on the basis of the received identification information. The control unit 11 acquires the name of the second nurse from the nurse DB 152 of the high-capacity storage unit 15, on the basis of the acquired second nurse ID. The control unit 11 transmits the acquired second nurse ID and name to the nurse smart phone 3 by the communication unit 13.

The control unit 31 displays the acquired information relevant to the second nurse by the display unit 35 (step S306). The control unit 31 ends the processing.

In a case where the alert notification corresponding to the received manipulation is not the alert notification during response by the second nurse (NO in step S304), the control unit 31 receives the response manipulation by the nurse by the input unit 34 (step S307).

The control unit 31 updates the response status of the alert notification to be a manipulation target (step S308). Specifically, the control unit 31 transmits the management ID and the nurse ID corresponding to the alert notification to the server 1. The control unit 11 of the server 1 stores the response status, which is “during response”, and the nurse ID during response in the alert notification management DB 154, in association with the management ID transmitted from the nurse smart phone 3. The control unit 31 ends the processing.

Subsequently, processing of periodically notifying an unresponded alert will be described. In a case where it is a predetermined date and time, or in a case where a predetermined period of time has elapsed from the alert notification, the server 1 extracts the unresponded alert from the alert notification management DB 154, and transmits the extracted unresponded alert to the nurse smart phone 3. The predetermined date and time may be a time (for example, 9:01, 9:02, 9:03, . . . ) designated at a predetermined cycle (for example, once a minute).

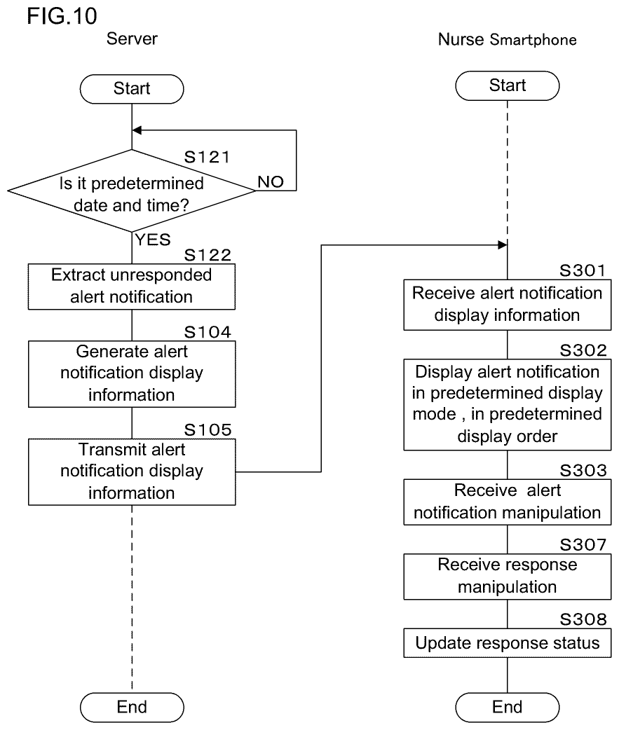

FIG. 10 is a flowchart illustrating a processing procedure when the unresponded alert is periodically notified. Note that the same reference numerals will be applied to the contents overlapping with those in FIG. 9, and the description will be omitted. The control unit 11 of the server 1 determines whether it is the predetermined date and time, on the basis of the current date and time (step S121). In a case where it is not the predetermined date and time (NO in step S121), the control unit 11 is on stand-by.

In a case where it is the predetermined date and time (YES in step S121), the control unit 11 extracts an unresponded alert notification from the alert notification management DB 154 of the high-capacity storage unit 15 (step S122). Specifically, the control unit 11 acquires the alert ID and the patient ID from the alert notification management DB 154 of the high-capacity storage unit 15, on the basis of the response status, which is “unresponded”. The control unit 11 executes the processing of step S104.

Note that in this embodiment, the transmission/reception between the patient smart phone 2 and the nurse smart phone 3 is performed through the server 1, but is not limited thereto. For example, various types of information may be directly transmitted/received between the patient smart phone 2 and the nurse smart phone 3. Specifically, in a case where the identification information of the patient may be stored in advance in the storage unit 32 of the nurse smart phone 3, and the nurse smart phone 3 receives the alert notification transmitted from the patient smart phone 2, the plurality of alert notifications of the patients with different identification information are displayed on the display unit 35, in association with the identification information of each patient stored in the storage unit 32.

Alternatively, by a distributed ledger technology such as a blockchain network, various types of information may be directly transmitted/received between a plurality of patient smart phones 2 and a plurality of nurse smart phones 3 using the patient smart phone 2 and the nurse smart phone 3 as a node.

According to this embodiment, by displaying the alert notification according to the nurse call of each patient on the nurse smart phone 3, it is possible to contribute to an efficient and flexible operation of a medical facility.

According to this embodiment, by using the patient smart phone 2 and the nurse smart phone 3, it is not necessary to separately prepare a dedicated nurse call device, which makes it possible to reduce the cost for introducing facilities.

According to this embodiment, it is possible to periodically notify the unresponded alert to the nurse smart phone 3.

### MODIFICATION EXAMPLE 1

Processing of displaying a plurality of shortcut objects according to a request from the patient on the display unit 25 of the patient smart phone 2 together with the nurse call object will be described. The shortcut object is an object set in accordance with the request from the patient. The request from the patient, for example, includes infusion end, infusion blockage, pain, ice pouch change, sputum suction, toilet assistance, diaper change, meal end, injection end, or the like.

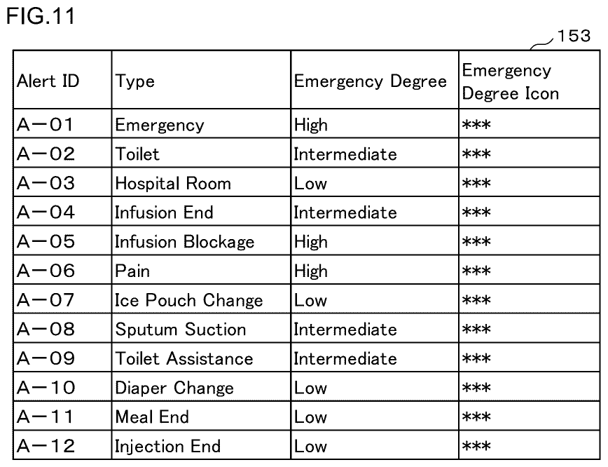

FIG. 11 is an explanatory diagram illustrating an example of the record layout of the alert setting DB 153 in Modification Example 1. Note that the description of the contents overlapping with FIG. 4 will be omitted. As illustrated in FIG. 11, the type of alert notification is classified in accordance with the request of the patient or the place, and the like, and for example, includes “emergency”, “toilet”, “hospital room”, “infusion end”, “infusion blockage”, “pain”, “ice pouch change”, “sputum suction”, “toilet assistance”, “diaper change”, “meal end”, “injection end”, or the like.

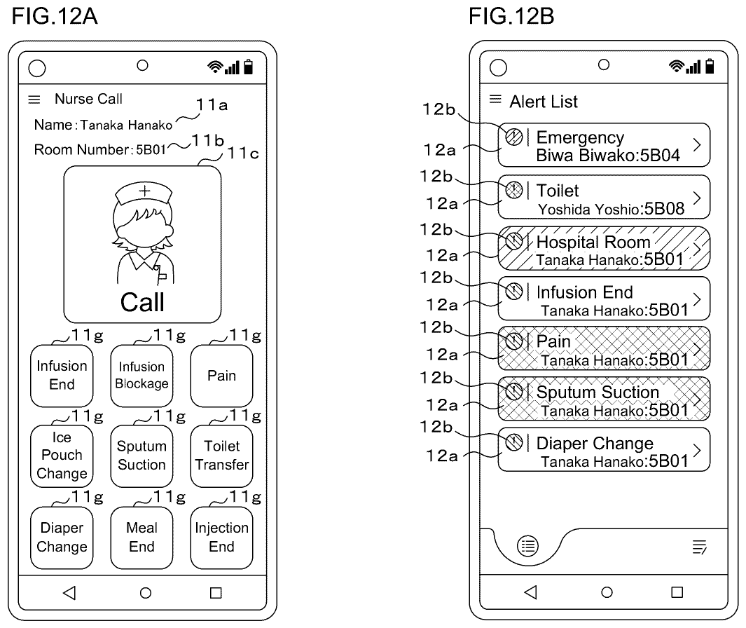

FIG. 12A and FIG. 12B are explanatory diagrams illustrating an example of a reception screen and a display screen in Modification Example 1. Note that the same reference numerals will be applied to the contents overlapping with those in FIG. 6A, FIG. 6B, FIG. 6C and FIG. 7, and the description will be omitted. FIG. 12A is an explanatory diagram illustrating an example of the reception screen of the nurse call in Modification Example 1. The reception screen includes a plurality of shortcut objects 11g.

The shortcut object 11g is an icon for receiving the nurse call according to the request from the patient. Note that in FIG. 12A, an example of the shortcut object 11g according to the infusion end, the infusion blockage, the pain, the ice pouch change, the sputum suction, the toilet assistance, the diaper change, the meal end, and the injection end, but is not limited thereto. For example, the shortcut object 11g according to a request such as providing meal, making bed, or changing posture may be provided.

In addition, in a case where the shortcut object 11g is pressed, the balloon icon (the second object) may be displayed in association with the shortcut object 11g, or the color or the size of the shortcut object 11g may be changed. In addition, in a case where the shortcut object 11g is pressed, the display format may be changed such that the shortcut object 11g is shown as being pressed.

In a case where the touch manipulation of the shortcut object 11g is received, the patient smart phone 2 transmits the identification information (for example, the name and the room number of the patient) for identifying the patient who has performed the manipulation and the type of alert notification corresponding to the shortcut object 11g to the server 1.

The server 1 receives the identification information of the patient and the type of alert notification transmitted from the patient smart phone 2. The server 1 transmits the alert notification including the identification information and the type of alert notification transmitted from each of the patient smart phones 2 to the nurse smart phone 3. The nurse smart phone 3 receives the plurality of alert notifications of the patients with different identification information transmitted from the server 1. The nurse smart phone 3 displays the received plurality of alert notifications on the display unit 35.

FIG. 12B is an explanatory diagram illustrating an example of the display screen of the alert notification in Modification Example 1. The server 1 generates the alert notification display information (the identification information of the patient, the type of alert notification, the emergency degree, the emergency degree icon, or the like) for displaying the plurality of alert notifications of the patients with different identification information. Specifically, the server 1 acquires the identification information of the patient including the name or the room number of the patient from the patient DB 151, on the basis of each patient ID. The server 1 acquires the type of alert notification, the emergency degree, and the emergency degree icon form the alert setting DB 153, on the basis of the alert ID corresponding to each patient. The control unit 11 generates the alert notification display information including the acquired identification information, the type of alert notification, the emergency degree, the emergency degree icon, or the like, for each patient.

The server 1 transmits the generated alert notification display information to the nurse smart phone 3. The nurse smart phone 3 receives the alert notification display information transmitted from the server 1. The nurse smart phone 3 displays the received alert notification display information on the alert notification display section 12a, in predetermined display order (for example, the descending order of the emergency degree). As illustrated, in the alert notification display section 12a, the type of alert notification (the emergency, the toilet, the hospital room, the infusion end, the pain, the sputum suction, the diaper change, or the like), and the name and the room number of the patient are displayed.

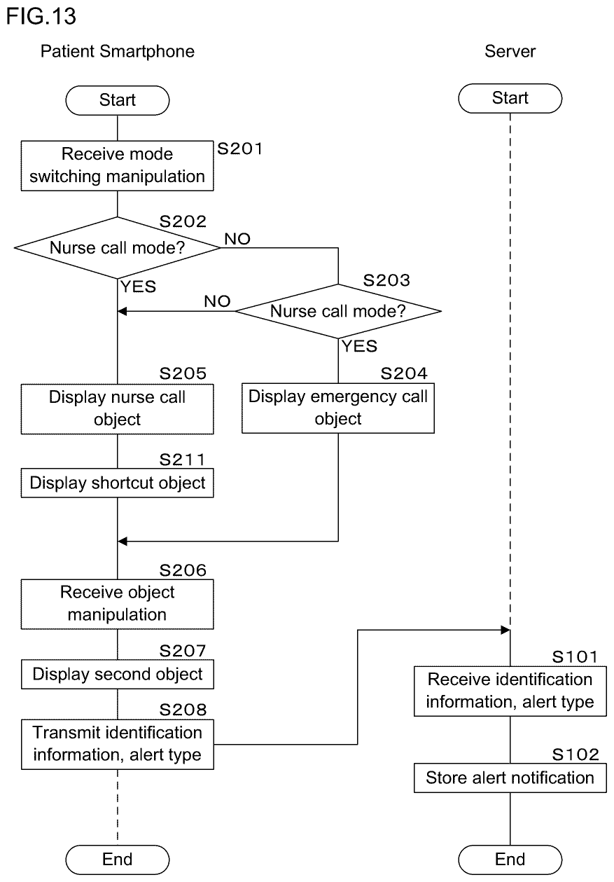

FIG. 13 is a flowchart illustrating a processing procedure when the nurse call in Modification Example 1 is received. Note that the same reference numerals will be applied to the contents overlapping with those in FIG. 8, and the description will be omitted. The control unit 21 of the patient smart phone 2 executes the processing of step S205, and then, displays a single or a plurality of shortcut objects (the shortcut object 11g in FIG. 12A) according to the request from the patient by the display unit 25 (step S211). The control unit 21 executes the processing of step S206.

According to this embodiment, it is possible to display the alert notification according to the shortcut object on the nurse smart phone 3.

According to this embodiment, by providing the plurality of shortcut objects 11g for flexibly delivering the request from the patient to the nurse, it is possible to save a communication time.

### MODIFICATION EXAMPLE 2

Processing of simultaneously notifying a sound or a text to each of the patient smart phones 2 from the nurse smart phone 3 will be described.

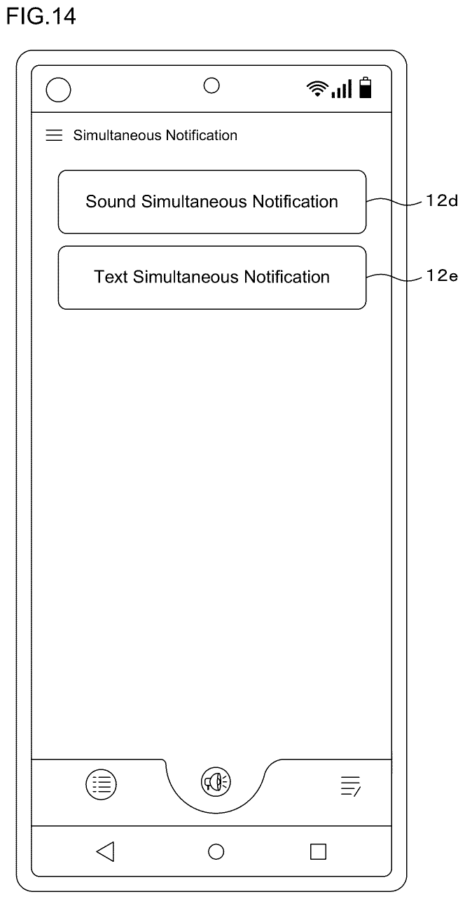

FIG. 14 is an explanatory diagram illustrating an example of the display screen of the alert notification in Modification Example 2. The display screen includes a sound simultaneous notification button 12d and a text simultaneous notification button 12e.

The sound simultaneous notification button 12d is a button for simultaneously notifying a sound to the plurality of patient smart phones 2. The text simultaneous notification button 12e is a button for simultaneously notifying a text to the plurality of patient smart phones 2. Note that the display format of the sound simultaneous notification button 12d and the text simultaneous notification button 12e is not limited to the button, and for example, may be an object such as an icon or an image.

In a case where the manipulation (for example, the touch) of the sound simultaneous notification button 12d is received, the nurse smart phone 3 receives the input sound. The content of the sound, as an example, may be “The fire alarm has been activated in the hospital ward. Please evacuate immediately”. The nurse smart phone 3 transmits the received sound to the server 1. The server 1 receives the sound transmitted from the nurse smart phone 3. The server 1 transmits the received sound to each of the patient smart phones 2. Each of the patient smart phones 2 outputs the sound transmitted from the server 1 through the speaker 27.

In a case where the manipulation (for example, the touch) of the text simultaneous notification button 12e is received, the nurse smart phone 3 receives the input text. The text, as an example, may be “There is still a flu epidemic. Please be sure to wash your hands and wear a mask!”. The nurse smart phone 3 transmits the received text to the server 1. The server 1 receives the text transmitted from the nurse smart phone 3. The server 1 transmits the received text to each of the patient smart phones 2. Each of the patient smart phones 2 displays the text transmitted from the server 1 by the display unit 25.

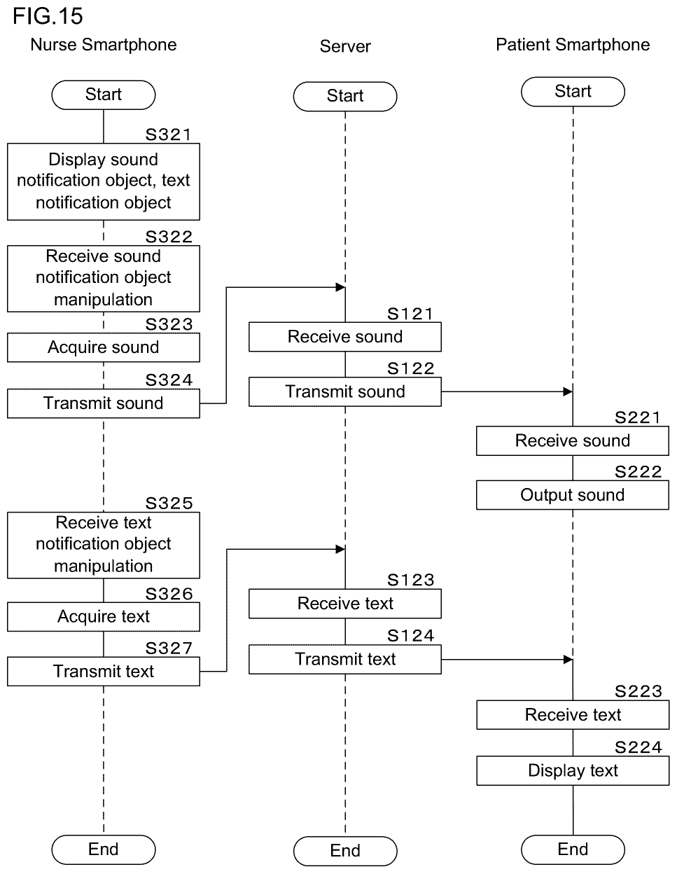

FIG. 15 is a flowchart illustrating a processing procedure when the sound or the text is simultaneously notified. The control unit 31 of the nurse smart phone 3 displays a sound notification object (for example, the sound simultaneous notification button 12d in FIG. 14) for simultaneously notifying the sound to the plurality of patients and a text notification object (for example, the text simultaneous notification button 12e in FIG. 14) for simultaneously notifying the text to the plurality of patients by the display unit 35 (step S321).

The control unit 31 receives the manipulation (for example, the touch) of the sound notification object by the input unit 34 (step S322). The control unit 31 acquires the sound received after the manipulation of the sound notification object (step S323). The control unit 31 transmits the acquired sound to the server 1 by the communication unit 33 (step S324).

The control unit 11 of the server 1 receives the sound transmitted from the nurse smart phone 3 by the communication unit 13 (step S121). The control unit 11 transmits the received sound to each of the patient smart phones 2 by the communication unit 13 (step S122). The control unit 21 of each of the patient smart phones 2 receives the sound transmitted from the server 1 by the communication unit 23 (step S221). The control unit 21 outputs the received sound through the speaker 27 (step S222).

The control unit 31 of the nurse smart phone 3 receives the manipulation (for example, the touch) of the text notification object by the input unit 34 (step S325). The control unit 31 acquires the text received after the manipulation of the text notification object (step S326). The control unit 31 transmits the acquired text to the server 1 by the communication unit 33 (step S327).

The control unit 11 of the server 1 receives the text transmitted from the nurse smart phone 3 by the communication unit 13 (step S123). The control unit 11 transmits the received text to each of the patient smart phones 2 by the communication unit 13 (step S124). The control unit 21 of each of the patient smart phones 2 receives the text transmitted from the server 1 by the communication unit 23 (step S223). The control unit 21 displays the received text through the display unit 25 (step S224). The control unit 21 ends the processing.

According to this modification example, by simultaneously notifying the sound or the text to each of the patient smart phones 2 from the nurse smart phone 3, it is possible to share emergency or important information.

### EMBODIMENT 2

Embodiment 2 relates to a form in which the video call between the patient corresponding to the alert notification and the nurse is established. Note that the description of the contents overlapping with those in Embodiment 1 will be omitted.

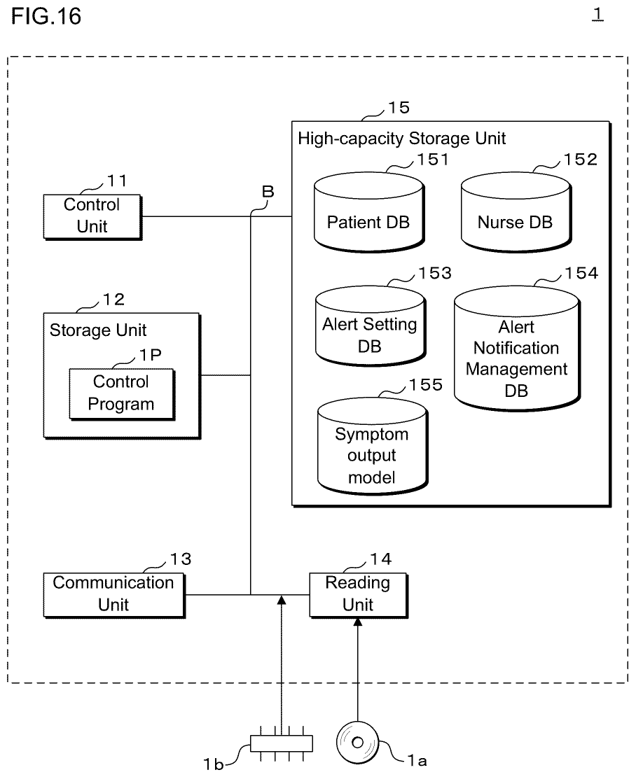

FIG. 16 is a block diagram illustrating a configuration example of the server 1 in Embodiment 2. Note that the same reference numerals will be applied to the contents overlapping with those in FIG. 2, and the description will be omitted. In the high-capacity storage unit 15, a symptom output model 155 is included. The symptom output model 155 is an output device outputting (assuming) information relevant to the symptom of the patient, on the basis of the moving image data in the video call of the patient, and is a trained model generated by machine learning. Note that the symptom output model 155 will be described below.

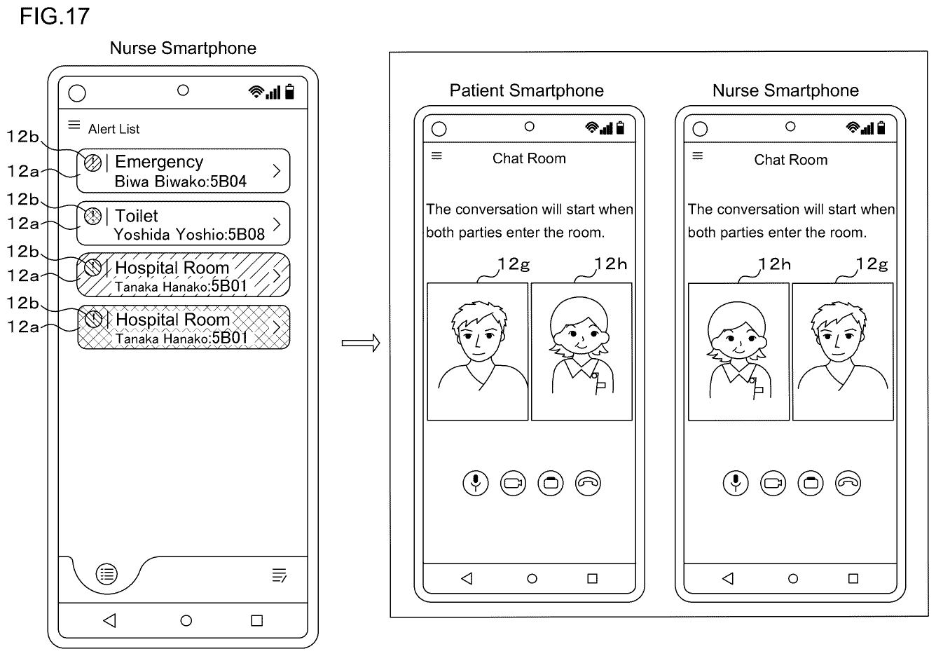

FIG. 17 is an explanatory diagram illustrating an example of a screen of the video call. Note that the same reference numerals will be applied to the contents overlapping with those in FIG. 7, and the description will be omitted. The screen includes a patient video call section 12g and a nurse video call section 12h.

In a case where the video call between the patient corresponding to the alert notification and the nurse is established, the patient video call section 12g and the nurse video call section 12h are a display section for displaying a screen of a chat room in which the video call is performed. Note that in the case of sound communication only, only the sound communication may be established without displaying a video in the patient video call section 12g and the nurse video call section 12h.

The patient smart phone 2 transmits a video call request to the server 1. The video call request, for example, includes the nurse ID, the patient ID, the alert ID, connection request information indicating a communication session connection request for establishing the video call (the video communication) between the nurse and the patient, or the like. The connection request information, for example, includes network information (an internet protocol (IP) address or the like) of the nurse smart phone 3, the uniform resource locator (URL) of the video call, an ID or an authentication key for establishing secure communication, and the like.

The server 1 receives the video call request transmitted from the patient smart phone 2, and transmits the received video call request to the nurse smart phone 3. The nurse smart phone 3 receives the video call request transmitted from the server 1. The nurse smart phone 3 receives the selection of the alert notification to be the response target among the plurality of alert notifications. The nurse smart phone 3 transmits connection response information that is permission to establish the video call with respect to the patient smart phone 2 to the server 1 through a check screen (not illustrated) on the call screen, in accordance with the received video call request.

The connection response information includes a response status, network information of a connection source (the patient smart phone 2), network information of a connection destination (the nurse smart phone 3), a security token for joining the call, and the like. The server 1 performs processing of establishing the video call between the patient smart phone 2 and the nurse smart phone 3, in accordance with the connection response information transmitted from the nurse smart phone 3. Note that the server 1 may establish only the sound communication between the patient smart phone 2 and the nurse smart phone 3.

Note that for video call establishment processing, for example, a technology such as a video call system performing transmission/reception in real time between terminals through the Internet, or an application programming interface (API) for a video call may be used. As described above, in a case where the video communication between the nurse and the patient is established, the nurse can visually check the status of the patient, and make an appropriate response.

The server 1 records the established video call. After the video call is ended, the server 1 stores the response status, which is “responded”, and the moving image data in the recorded video call in the alert notification management DB 154, in association with the nurse ID, the patient ID, and the alert ID.

In addition, the information relevant to the symptom of the patient can be output on the basis of the moving image data in the video call. Specifically, the server 1 acquires the moving image data corresponding to the alert notification from the alert notification management DB 154, on the basis of the management ID of the alert notification. The moving image data includes a frame image (a video image), and sound data (conversation contents in the video call).

The server 1 inputs the acquired moving image data to the symptom output model 155, and outputs the information relevant to the symptom of the patient. The information relevant to the symptom of the patient includes a fever, a cough, a headache, a sense of fatigue, breathing difficulty, the presence or absence of a digestive symptom (for example, nausea, vomiting, a diarrhea, or an abdominal pain), an injury state (for example, a sprain, a cut, or a bruise), or the like.

The symptom output model 155 is used as a program module that is a part of artificial intelligence software. In a case where the moving image data in the video call between the patient and the nurse is input, the symptom output model 155 is a learning model for outputting the information relevant to the symptom of the patient.

The symptom output model 155, for example, may be generated (constructed) by using a deep neural network(s) (DNN), a convolution neural network (CNN), a region(s) with convolutional neural network (RCNN), a fast RCNN, a faster RCNN, a single shot multibook detector (SSD), you only look once (YOLO), a support vector machine (SVM), a Bayesian network, a Transformer network, a regression tree, or the like.

The server 1 generates the symptom output model 155 by using training data. The training data is combination data in which the moving image data (the frame image and the sound data) in the video call between the patient and the nurse is associated with the information relevant to the symptom of the patient (a fever, a sense of fatigue, or the like). The learning processing of the symptom output model 155, for example, is performed by optimizing parameters on the basis of massive training data such that output data approaches ground truth data, and learning (updating) parameter information included in the symptom output model 155.

Note that in this embodiment, an example of the symptom output model 155 constructed on the basis of the frame image and the sound data included in the moving image data has been described, but is not limited thereto. The symptom output model 155, for example, may be trained model generated on the basis of only one of the frame images and the sound data included in the moving image data.

Note that the moving image data may be input to large language models (LLM), and the information relevant to the symptom of the patient may be output by zero-shot learning or few shot learning of the language model.

The server 1 transmits the information relevant to the symptom of the patient (for example, a cough or nausea) output from the symptom output model 155 to the nurse smart phone 3. The nurse smart phone 3 receives the information relevant to the symptom of the patient transmitted from the server 1. The nurse smart phone 3 displays the received information relevant to the symptom of the patient on the screen.

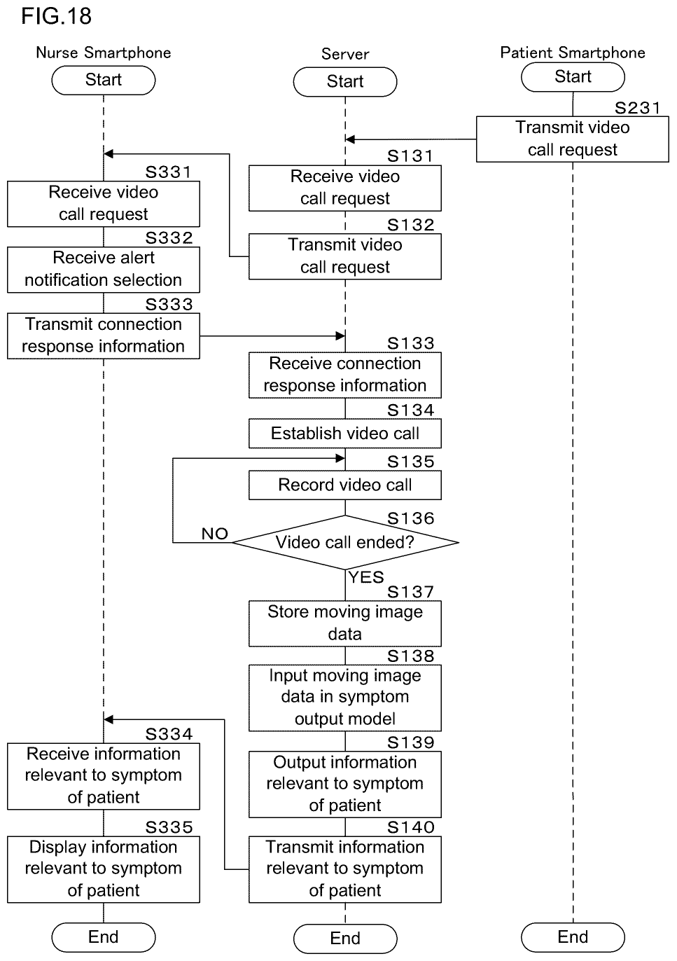

FIG. 18 is a flowchart illustrating a processing procedure when the video call between the patient and the nurse is established. The control unit 21 of the patient smart phone 2 transmits the video call request including the nurse ID, the patient ID, the alert ID, and the connection request information indicating the communication session connection request for establishing the video call between the patient and the nurse, or the like to the server 1 by the communication unit 23 (step S231).

The control unit 11 of the server 1 receives the video call request transmitted from the patient smart phone 2 through the communication unit 13 (step S131), and transmits the received video call request to the nurse smart phone 3 (step S132). The control unit 31 of the nurse smart phone 3 receives the video call request transmitted from the server 1 by the communication unit 33 (step S331).

The control unit 31 receives the selection of the alert notification to be the response target among the plurality of alert notifications by the input unit 34 (step S332). The control unit 31 transmits the connection response information (the response status, the connection source or connection destination network information, and the like) that is the permission for establishing the video call with respect to the patient smart phone 2 through the check screen on the call screen, in accordance with the received video call request to the server 1 by the communication unit 33 (step S333).

The control unit 11 of the server 1 receives the connection response information transmitted from the nurse smart phone 3 by the communication unit 13 (step S133). The control unit 11 performs the processing of establishing the video call between the patient smart phone 2 and the nurse smart phone 3, in accordance with the received connection response information (step S134). The control unit 11 records the established video call (step S135).

The control unit 11 determines whether the video call is ended (step S136). In a case where the video call is not ended (NO in step S136), the control unit 11 returns to the processing of step S135. In a case where the video call is ended (YES in step S136), the control unit 11 stores the response status, which is “responded”, and the moving image data in the recorded video call in the alert notification management DB 154 of the high-capacity storage unit 15, in association with the nurse ID, the patient ID, and the alert ID (step S137).

The control unit 11 inputs the recorded moving image data in the symptom output model 155 (step S138), and outputs the information relevant to the symptom of the patient (a fever, a sense of fatigue, or the like) (step S139). The control unit 11 transmits the information relevant to the symptom of the patient output from the symptom output model 155 to the nurse smart phone 3 by the communication unit 13 (step S140).

The control unit 31 of the nurse smart phone 3 receives the information relevant to the symptom of the patient transmitted from the server 1 by the communication unit 33 (step S334). The control unit 31 displays the received information relevant to the symptom of the patient by the display unit 35 (step S335). The control unit 31 ends the processing.

According to this embodiment, by establishing the video call between the patient corresponding to the alert notification and the nurse, it is possible for the nurse to easily grasp a change in the physical condition of the patient.

According to this embodiment, by using the video call, it is possible to save the travel time of the nurse, and improve a work efficiency.

### EMBODIMENT 3

Embodiment 3 relates to a form in which the evaluation of each nurse according to the number of responses of each nurse with respect to the alert notification is output. Note that the description of the contents overlapping with those in Embodiments 1 and 2 will be omitted.

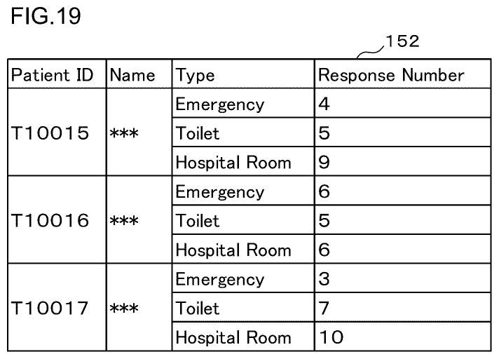

FIG. 19 is an explanatory diagram illustrating an example of the record layout of the nurse DB 152 in Embodiment 3. Note that the description of the contents overlapping with those in FIG. 3 will be omitted. The nurse DB 152 includes a type column and a number of responses column. In the type column, the type of alert notification is stored.

In the number of responses column, the number of responses of the nurse with respect to the alert notification is stored for each type of alert notification. Note that the number of responses of each nurse with respect to the alert notification is counted up from the alert notification management DB 154 using the number of responses of the alert notification of which the response status is “responded” as a counting target, on the basis of the nurse ID.

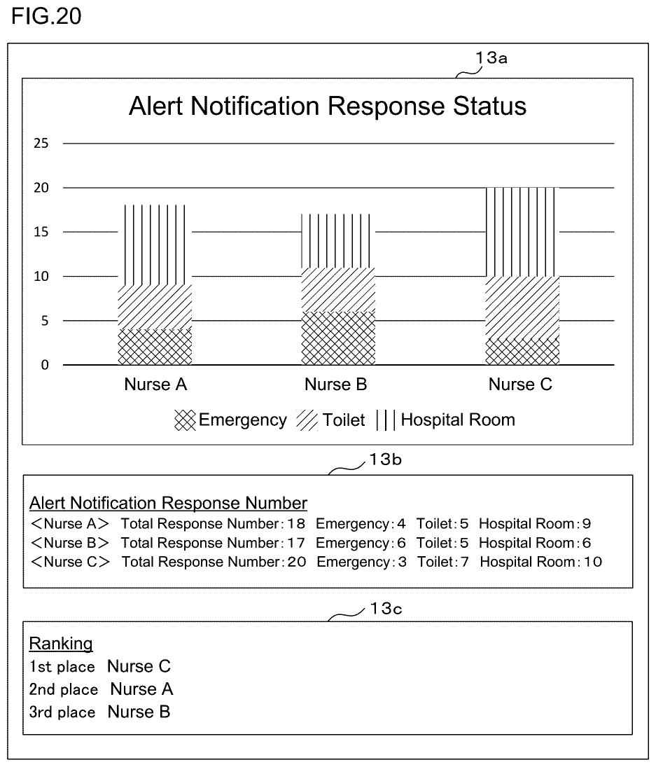

FIG. 20 is an explanatory diagram illustrating an example of the display screen of the evaluation of each nurse. The display screen includes a response status graph 13a, a number of responses display section 13b, and a ranking display section 13c. The response status graph 13a is a graph indicating the response status of each nurse with respect to the alert notification. The number of responses display section 13b is a display section for displaying the number of responses of each nurse with respect to the alert notification. The ranking display section 13c is a display section for displaying the ranking of each nurse.

The server 1 acquires the number of responses of the alert notification for each type of alert notification from the nurse DB 152, on the basis of the nurse ID of each nurse. The server 1 generates the graph indicating the response status of each nurse with respect to the alert notification, on the basis of the acquired number of responses of the alert notification for each type of alert notification.

The server 1 calculates the ranking of each nurse, on the basis of the total number of responses of each nurse. Note that the ranking of each nurse may be calculated on the basis of a score obtained by weighting and adding the number of responses of the alert notification for each type of alert notification. For example, the weighting coefficient of the emergency is 1.5, the weighting coefficient of the toilet is 0.8, and the weighting coefficient of the hospital room is 0.7. Note that the weighting coefficient may be set in accordance with the emergency degree, the important degree, or the like of the alert notification. In this case, the score of each nurse is calculated by a calculus equation of “Number of Responses of Emergency×1.5+Number of Responses of Toilet×0.8+Number of Responses of Hospital Room×0.7”. The server 1 calculates the ranking of each nurse, on the basis of the calculated score of each nurse.

The server 1 transmits the generated graph, the name of each nurse, the number of responses of the alert notification for each type of alert notification, and the ranking of each nurse, for example, to an administrator terminal, in association with each nurse ID. Note that instead of the administrator terminal, the server 1 may output such information to a monitor connected to the server 1. The administrator terminal receives the graph, the nurse ID and the name of each nurse, the number of responses of the alert notification for each type of alert notification, and the ranking of each nurse, which are transmitted from the server 1.

The administrator terminal displays the received graph in the response status graph 13a. As illustrated, the response status graph 13a is indicated in the format of a stacked column chart. Note that the response status graph 13a is in the format of a stacked column chart, but is not limited thereto, and may be in other graph formats (for example, a stacked bar chart or a pie chart).

A horizontal axis in the response status graph 13a indicates the name of the nurse (for example, a nurse A, a nurse B, and a nurse C), and a vertical axis indicates the number of responses of each nurse with respect to the alert notification. The details of the vertical axis in the response status graph 13a are the number of responses with respect to the alert notification corresponding to each of “emergency”, “toilet”, and “hospital room”, which are the type of alert notification. The “emergency” is illustratively indicated by diamond (the frame only). The “toilet” is illustratively indicated by diagonally right up hatching. The “hospital room” is illustratively indicated by vertical hatching.

As illustrated, in the response status graph 13a, for each nurse, the number of responses of the alert notification corresponding to each of “emergency”, “toilet”, and “hospital room” is displayed.

The administrator terminal displays the total number of responses, and the number of responses of the alert notification for each type of alert notification in the number of responses display section 13b, in association with the received name of each nurse. The administrator terminal displays the ranking of each nurse in the ranking display section 13c, in association with the name of each nurse.

Note that in FIG. 20, an example of the evaluation of each nurse according to the number of responses with respect to the alert notification has been described, but is not limited thereto. For example, after the alert notification is responded, a questionnaire survey may be implemented on the patient. For example, a questionary investigation is performed on the nurse, including communication capability, politeness, a response speed to the request from the patient, or the like to collect the score (for example, 1 point to 5 points) of the satisfactory degree of the patient. In this case, the server 1 may output the evaluation of each nurse according to both of the counted score of the satisfactory degree of the patient and the number of responses with respect to the alert notification. Alternatively, the degree of busyness may be evaluated by comparing the number of nurse responses for each hospital ward, and evaluation for attaining appropriate personnel positioning may be used.

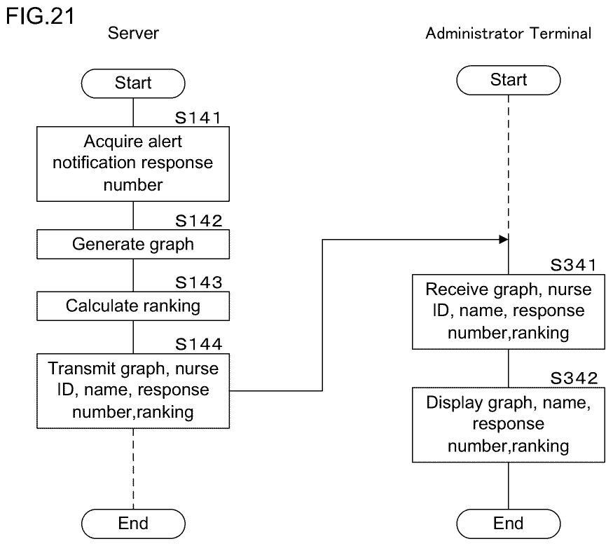

FIG. 21 is a flowchart illustrating a processing procedure when the evaluation of each nurse is output. The control unit 11 of the server 1 acquires the number of responses of the alert notification for each type of alert notification, on the basis of the nurse ID of each nurse from the nurse DB 152 of the high-capacity storage unit 15 (step S141). The control unit 11 generates the graph indicating the response status of each nurse with respect to the alert notification, on the basis of the acquired number of responses of the alert notification for each type of alert notification (step S142).

The control unit 11 calculates the ranking of each nurse, on the basis of the total number of responses of each nurse (step S143). The control unit 11 transmits the generated graph, the name of each nurse, the number of responses of the alert notification for each type of alert notification, and the ranking of each nurse to the administrator terminal through the communication unit 13, in association with each nurse ID (step S144).

The administrator terminal receives the graph, the nurse ID and the name of each nurse, the number of responses of the alert notification for each type of alert notification, and the ranking of each nurse, which are transmitted from the server 1 (step S341). The administrator terminal displays the graph, the name of each nurse, the number of responses of the alert notification for each type of alert notification, and the ranking of each nurse, which are received (step S342). The administrator terminal ends the processing.

According to this embodiment, since the administrator of the facility implements appropriate evaluation on the nurse by evaluating each nurse according to the number of responses with respect to the alert notification, it is possible to attain appropriate personnel positioning.

### EMBODIMENT 4

Embodiment 4 relates to a form in which the alert notification is displayed on the nurse smart phone 3 when the nurse call button or the emergency nurse call button provided in the place including the hospital room or the toilet is manipulated. Note that the description of the contents overlapping with those in Embodiments 1 to 3 will be omitted.

In a case where the patient does not have the patient smart phone 2 at hand in a place such as a bathroom or a toilet, or in a case where the power of the patient smart phone 2 is off or there is no signal, there is a possibility that the use of the nurse call or the emergency call in the patient smart phone 2 is restricted.

In order to ensure patient safety, in a place including a hospital room, a bathroom, a toilet, or the like, the nurse call button (for example, a toilet nurse call button or a hospital room nurse call button), or the emergency nurse call button is provided. In a case where the nurse call button or the emergency nurse call button provided in such a place is manipulated by the patient, the server 1 transmits the alert notification including the type of button and the identification information of the patient to the nurse smart phone 3.

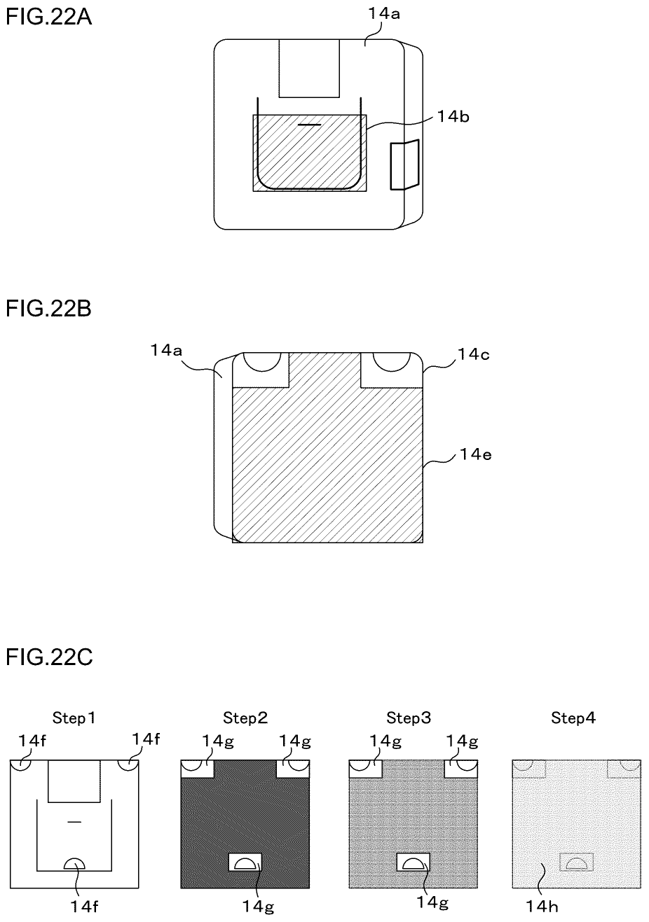

FIG. 22A, FIG. 22B and FIG. 22C are schematic views illustrating the appearance of the nurse call button or the emergency nurse call button.

FIG. 22A is a schematic view illustrating an example of the appearance of a normal nurse call button or emergency nurse call button. As illustrated, a button 14a is a normal nurse call button or emergency nurse call button. The button 14a, for example, may be a U-shaped button of which only a part is pressed. A normal region 14b is a frame indicating a range (a region) in which the surface of the button 14a is pressed.

FIG. 22B is a schematic view illustrating an example of the appearance of a toilet nurse call button or an emergency nurse call button with a cover. A cover 14c is attached onto the button 14a such that the button 14a of which only a part is pressed is wholly pressed. A cover region 14e is a frame indicating a range in which the surface of the button 14a to which the cover 14c is attached is pressed.

FIG. 22C is an explanatory diagram illustrating an example of how to make the cover 14c. As an example, in step 1, a urethane cushion seal 14f is stuck to a predetermined spot on the surface of the button 14a. The predetermined spot is any spot, and as illustrated, may be the upper right, upper left, and the lower side of the normal region 14b. In step 2, a sponge sheet 14g cut to surround the urethane cushion seal 14f is stuck onto the urethane cushion seal 14f.

In step 3, a double sided tape, an adhesive agent, or the like is stuck to the sponge sheet 14g. Note that in a case where the sponge sheet 14g is a double sided seal, step 3 can be omitted. In step 4, a transparent plate 14h matching the size of the button 14a is stuck onto the button 14a to which the sponge sheet 14g is stuck.

In this embodiment, either the normal button 14a or the button 14a to which the cover 14c is attached may be provided in the place including the hospital room, the bathroom, the toilet, or the like.

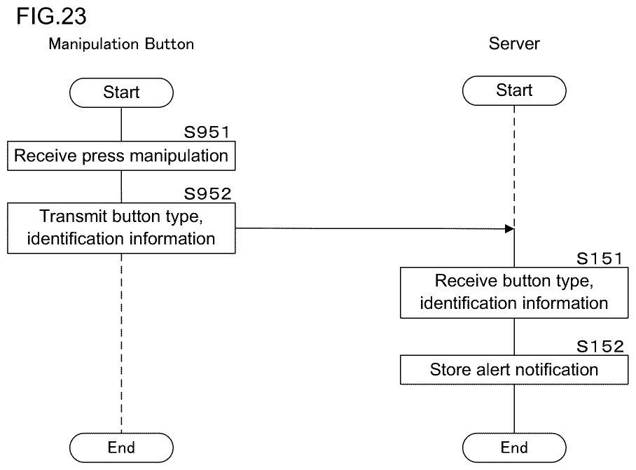

FIG. 23 is a flowchart illustrating a processing procedure when the alert notification is transmitted to the nurse smart phone 3 in a case where the button is manipulated. The button includes the nurse call button, the emergency nurse call button, or the like, provided in the place including the hospital room or the toilet.

A button to be a manipulation target (hereinafter, will be replaced with a manipulation button) receives a press manipulation by the patient (step S951). The manipulation button transmits the type of button (for example, the toilet nurse call button, the hospital room nurse call button, or the emergency nurse call button), and the identification information to the server 1 (step S952). The identification information includes the name, the room number, or the like of the patient. Note that the manipulation button may transmit the type of button and the identification information to the server 1 through the patient smart phone 2 connected via near field communication such as Bluetooth (Registered Trademark) or a wireless LAN.

The control unit 11 of the server 1 receives the type of button and the identification information transmitted from the manipulation button by the communication unit 13 (step S151). The control unit 11 stores the alert notification in the alert notification management DB 154 of the high-capacity storage unit 15 (step S152).

Specifically, the control unit 11 acquires the corresponding alert ID from the alert setting DB 153 of the high-capacity storage unit 15 using the received type of button received as the type of alert notification, on the basis of the type of alert notification. The control unit 11 acquires the corresponding patient ID from the patient DB 151 of the high-capacity storage unit 15, on the basis of the received identification information of the patient. The control unit 11 assigns the management ID. The control unit 11 stores the acquired alert ID, the patient ID, the date and time when the alert is notified, and the response status, which is “unresponded”, as one record, in the alert notification management DB 154, in association with the assigned management ID. The control unit 11 ends the processing.

After that, as with the processing of Embodiment 1, the server 1 generates the alert notification display information for displaying the plurality of alert notifications of the patients with different identification information. In the alert notification display information, the type of button (the type of alert notification), and the identification information (the name, the room number, or the like of the patient) are included. Note that in the alert notification display information, an image or an icon indicating the toilet nurse call button, the hospital room nurse call button, or the emergency nurse call button, which is a physical button may be included. The server 1 transmits the generated alert notification display information to the nurse smart phone 3. The nurse smart phone 3 displays the alert notification display information transmitted from the server 1 on the display unit 35.

According to this embodiment, in a case where the nurse call button or the emergency nurse call button provided in the place including the hospital room or the toilet is manipulated, it is possible to display the alert notification on the nurse smart phone 3.

According to this embodiment, even in a case where the use of the nurse call or the emergency call in the patient smart phone 2 is restricted, it is possible to ensure the patient safety.

### EMBODIMENT 5

Embodiment 5 relates to a form in which a report document with respect to the alert notification is displayed on the nurse smart phone 3. Note that the description of the contents overlapping with those in Embodiments 1 to 4 will be omitted.

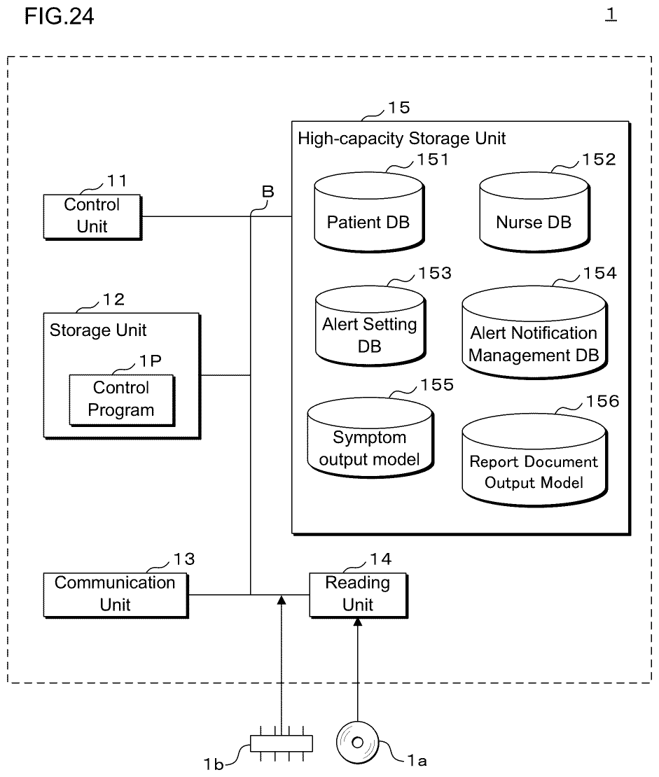

FIG. 24 is a block diagram illustrating a configuration example of the server 1 in Embodiment 5. Note that the same reference numerals will be applied to the contents overlapping with those in FIG. 16, and the description will be omitted. In the high-capacity storage unit 15, a report document output model 156 is included. The report document output model 156 is an output device outputting the report document, on the basis of a response result for the alert notification, and the conversation contents in the video call between the patient and the nurse, and is a trained model generated by machine learning.

The report document output model 156 is a language generation model constructed by performing pretraining using large text data (a data set). As the report document output model 156, for example, a large language model (LLM) such as Transformer, A Lite BERT (ALBERT), generative pre-trained transformer (GPT)-2, GPT-3, GPT-4, large language and vision assistant (LLaVA), MiniGPT-4, or bidirectional encoder representations from transformers (BERT) can be used.

The nurse smart phone 3 receives the input of the response result for the alert notification by the nurse. The response result for the alert notification, for example, includes the symptom of the patient, a treatment, an examination, prescription issuance, the adjustment of medication dosage, nurse information, a response date and time, or the like. The nurse smart phone 3 transmits the nurse ID, the management ID of the alert notification, and the received response result for the alert notification to the server 1.

The server 1 receives the nurse ID, the management ID of the alert notification, and the response result, which are transmitted from the nurse smart phone 3. The server 1 acquires the moving image data in the video call between the patient and the nurse from the alert notification management DB 154, on the basis of the received management ID of the alert notification.

The server 1 may perform analysis using a voice recognition engine or the like to convert sound data included in the acquired moving image data into a text. In the transcription of the sound data, for example, a sound text conversion tool such as an Azure speech application programming interface (API) may be used. Alternatively, the server 1 may convert the sound into the text using a trained model by machine learning such as artificial intelligence (AI).

The server 1 extracts the information relevant to the symptom of the patient (a fever, nausea, a chest ache, a sense of fatigue, or the like) that is the conversation contents in the video call from the transcribed sound data. Note that the server 1 may input the acquired moving image data to the symptom output model 155, and output the information relevant to the symptom of the patient.

The server 1 generates a prompt including the response result for the alert notification, and the extracted conversation contents in the video call. The server 1 provides (inputs) the generated prompt to the report document output model 156 to output the report document.

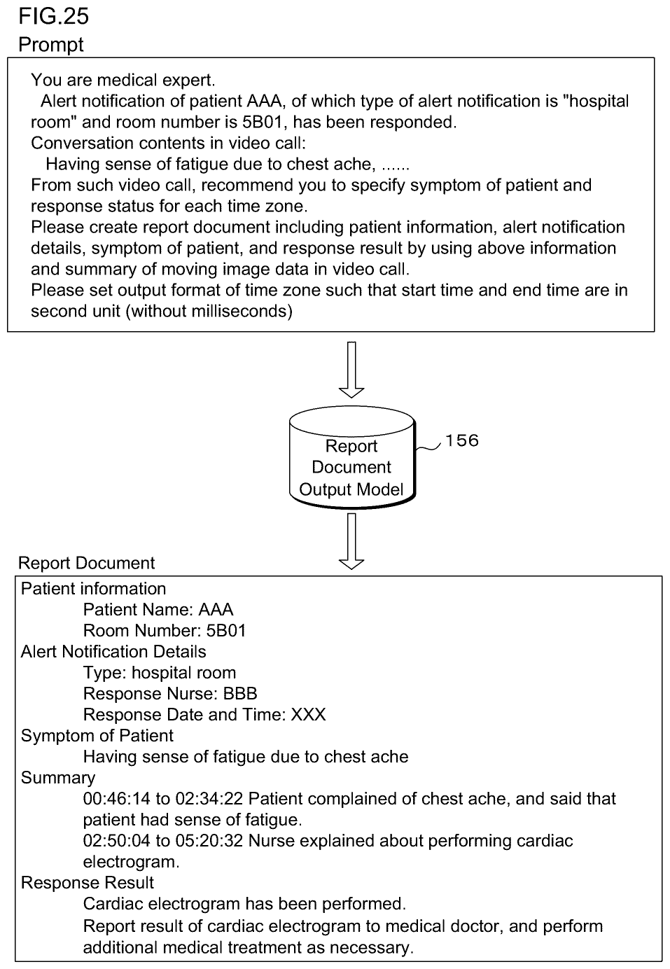

FIG. 25 is an explanatory diagram illustrating report document output processing by the report document output model 156. The report document output model 156 is a language generation model using the response result for the alert notification and the conversation contents in the video call, and is used as a program module that is a part of artificial intelligence software. The report document output model 156 is a constructed language generation model using the prompt including the response result for the alert notification, the conversation contents in the video call, and the like as input, and the report document corresponding to the alert notification as output.

Note that the report document output model 156 may be read out from an external language processing server, language processing platform, or the like by the access of the server 1, instead of being stored in the high-capacity storage unit 15.

The prompt is an instruction or an input statement that is created in a format comprehensible to the report document output model 156 and provided as the input of the report document output model 156. The report document output model 156 interprets the input prompt, and outputs an appropriate respond (for example, the report document).

As an example, the report document output model 156 divides the prompt into tokens such that the prompt is converted into a format that can be processed by the report document output model 156. The report document output model 156 performs context understanding processing by calculating a relation between each token in the prompt and other tokens.

The report document output model 156 performs response generation processing on the prompt, on the basis of language knowledge obtained by pretraining, minor adjustment, and the like. For example, the report document output model 156 selects the optimum token by using a generation method such as greedy decoding, beam search, or sampling. The report document output model 156 performs decoding processing on the selected token to return the token to a text format, and generates the report document to be the output data.

The prompt in this embodiment includes the identification information (the name, the room number, and the like) of the patient corresponding to the alert notification, the response result for the alert notification, creation instruction (command) information of the report document, or the like. The creation instruction information of the report document includes the name of the report document (for example, an incident report), a format, a report document item, a request (an instruction), or the like. The report document item, for example, includes the conversation contents in the video call, the nurse ID of the response nurse, the name of the nurse, the response date and time, or the like. The request, for example, includes a request to specify the symptom of the patient and the response status for each time zone, an extraction instruction for information required to create the summary of the moving image data, or the like.

As illustrated, as an example, the generated prompt may be
“You are medical expert.
Alert notification of patient AAA, of which type of alert notification is “hospital room” and room number is 5B01, has been responded.
Conversation contents in video call:
   Having sense of fatigue due to chest ache, . . .
From such video call, recommend you to specify symptom of patient and response status for each time zone.
Please create report document including patient information, alert notification details, symptom of patient, and response result by using above information and summary of moving image data in video call.
Please set output format of time zone such that start time and end time are in second unit (without milliseconds)”.

The server 1 inputs the generated prompt to the report document output model 156, and outputs the report document. As illustrated, the output report document may be
“Patient information
   Patient Name: AAA
   Room Number: 5B01

### Alert Notification Details

Type: hospital room
Response Nurse: BBB
Response Date and Time: XXX

### Symptom of Patient

Having sense of fatigue due to chest ache

### Summary

00:46:14 to 02:34:22 Patient complained of chest ache, and said that patient had sense of fatigue.
02:50:04 to 05:20:32 Nurse explained about performing cardiac electrogram.

### Response Result

Cardiac electrogram has been performed.
Report result of cardiac electrogram to medical doctor, and perform additional medical treatment as necessary”.

Note that in the output report document, a thumbnail image, link information (for example, URL), or the like of the moving image data corresponding to each time zone may be included. Note that the output report document may be a file such as a portable document format (PDF).

The server 1 transmits the report document output from the report document output model 156 to the corresponding nurse smart phone 3, on the basis of the nurse ID. The nurse smart phone 3 receives the report document transmitted from the server 1, and displays the received report document on the screen.

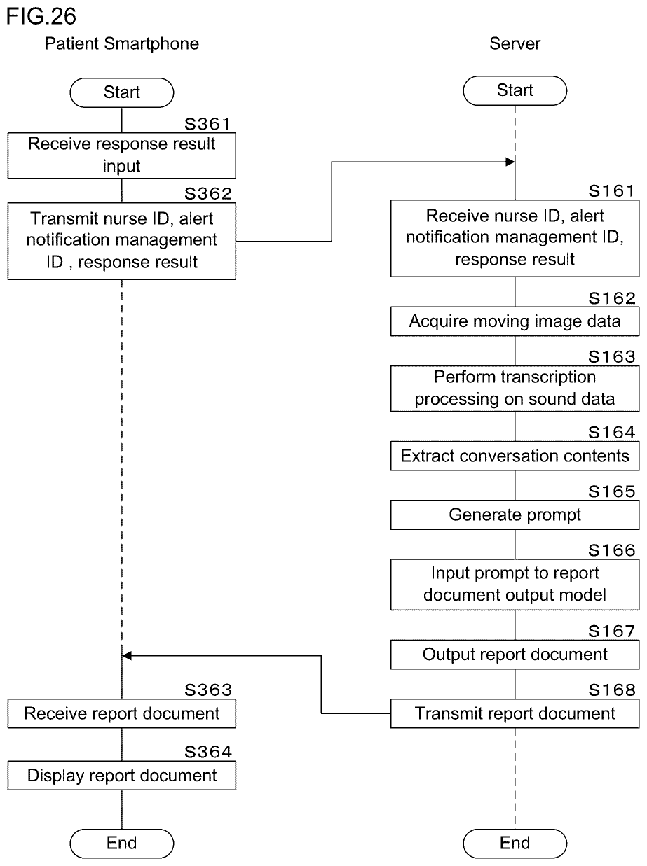

FIG. 26 is a flowchart illustrating a processing procedure when the report document with respect to the alert notification is displayed. The control unit 31 of the nurse smart phone 3 receives the input of the response result (the symptom of the patient, the treatment, the adjustment of the medication dosage, the response date and time, or the like) for the alert notification by the nurse via the input unit 34 (step S361). The control unit 31 transmits the nurse ID, the management ID of the alert notification, and the received response result for the alert notification to the server 1 by the communication unit 33 (step S362).

The control unit 11 of the server 1 receives the nurse ID, the management ID of the alert notification, and the response result, which are transmitted from the nurse smart phone 3, by the communication unit 13 (step S161). The control unit 11 acquires the moving image data in the video call between the patient and the nurse from the alert notification management DB 154 of the high-capacity storage unit 15, on the basis of the received management ID of the alert notification (step S162). The control unit 11 performs analysis using a voice recognition engine or the like to perform transcription processing on the sound data included in the acquired moving image data (step S163).

The control unit 11 extracts the conversation contents in the video call (the information relevant to the symptom of the patient, such as a fever, nausea, a chest ache, or a sense of fatigue) from the transcribed sound data (step S164). The control unit 11 generates the prompt including the response result for the alert notification, and the extracted conversation contents in the video call (step S165). The control unit 11 inputs the generated prompt to the report document output model 156 (step S166), and outputs the report document (step S167).

The control unit 11 transmits the report document output from the report document output model 156 to the nurse smart phone 3 by the communication unit 13, on the basis of the nurse ID (step S168). The control unit 31 of the nurse smart phone 3 receives the report document transmitted from the server 1 by the communication unit 33 (step S363), and displays the received report document on the display unit 35 (step S364). The control unit 31 ends the processing.

According to this embodiment, by displaying the report document with respect to the alert notification on the nurse smart phone 3, it is possible to share the patient state with the medical doctor, and provide a more appropriate medical treatment.

The embodiments disclosed herein should be considered as illustrative in all respects and not restrictive. The scope of the present invention is indicated by the claims, but not the meaning described above, and is intended to include the meaning equivalent to the claims and all modifications within the scope.

The respects described in each embodiment can be combined with each other. In addition, the independent and dependent claims set forth in the claims can be combined with each other in any and all combinations, regardless of the format of reference. Further, the claims are in a format in which a claim refers to two or more other claims (the format of a multiple dependent claim), but are not limited thereto.

The claims may be in a format in which a multiple dependent claim refers to at least one of multiple dependent claims (a multiple-multiple dependent claim).

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. An information processing method, comprising:
displaying a nurse call object on a first display unit of a smart phone of each patient, and
displaying, when a manipulation of the nurse call object is received, an alert notification including identification information for identifying a patient who has performed the manipulation on a second display unit of a smart phone of a nurse.

2. The information processing method according to claim 1,
wherein a plurality of alert notifications of patients with different identification information are displayed on the second display unit of the smart phone of the nurse.

3. The information processing method according to claim 2,
wherein in the plurality of alert notifications displayed on the second display unit, a display mode of an alert notification during response by a second nurse different from the nurse is different from a display mode of the alert notification.

4. The information processing method according to claim 3,
wherein when a manipulation of the alert notification during response is received, information relevant to the second nurse responding to the alert notification during response is displayed.

5. The information processing method according to claim 1,
wherein when a selection of the alert notification and a manipulation of a video call object are received, a video call between a patient corresponding to the alert notification and the nurse is established.

6. The information processing method according to claim 5,
wherein moving image data in the video call is acquired, and
information relevant to a symptom of the patient obtained by inputting the acquired moving image data to a learning model trained to output the information relevant to the symptom of the patient when the moving image data in the video call is input is displayed on the second display unit of the smart phone of the nurse.

7. The information processing method according to claim 1,
wherein when a switching manipulation between a nurse call mode according to a place including a hospital room or a toilet and an emergency mode is received, the nurse call mode and the emergency mode are switched and displayed on the first display unit of the smart phone of the patient,
in the nurse call mode, the nurse call object is displayed on the first display unit, and
in the emergency mode, an emergency call object is displayed on the first display unit.

8. The information processing method according to claim 7,
wherein when a manipulation of the nurse call object or the emergency call object is received, a second object indicating a state in which the manipulation is received is displayed in association with the nurse call object or the emergency call object.

9. The information processing method according to claim 1,
wherein a plurality of shortcut objects according to a request from the patient are displayed on the first display unit, together with the nurse call object, and
when a selection of the shortcut object is received, an alert notification including the identification information according to the received shortcut object is displayed on the second display unit of the smart phone of the nurse.

10. The information processing method according to claim 1,
wherein an unresponded alert is periodically notified to the smart phone of the nurse.

11. The information processing method according to claim 1,
wherein the number of responses by each nurse with respect to an alert notification is stored in a storage unit, and
an evaluation of each nurse according to the number of responses is output.

12. The information processing method according to claim 1,
wherein a report document obtained by providing a response result with respect to the alert notification, and a conversation content in a video call between the patient and the nurse to a language model is displayed on the second display unit of the smart phone of the nurse.

13. The information processing method according to claim 1,
wherein when a nurse call button or an emergency nurse call button provided in a place including a hospital room or a toilet is manipulated, an alert notification including a type of button and the identification information is displayed on the second display unit of the smart phone of the nurse.

14. The information processing method according to claim 1,
wherein a sound notification object for simultaneously notifying a sound to a plurality of patients is displayed on the second display unit of the smart phone of the nurse, and
the sound received after a manipulation of the sound notification object is output through a speaker of the smart phone of each patient.

15. The information processing method according to claim 1,
wherein a text notification object for simultaneously notifying a text to a plurality of patients is displayed on the second display unit of the smart phone of the nurse, and
the text received after a manipulation of the text notification object is displayed on the first display unit of the smart phone of each patient.

16. An information processing system, comprising:
smart phones of a plurality of patients, including a first display unit and a first control unit;
a smart phone of a nurse, including a second display unit and a second control unit; and
an information processing device including a third control unit,
wherein the first control unit of the smart phone of each patient displays a nurse call object on the first display unit, and
transmits, when a manipulation of the nurse call object is received, identification information for identifying a patient who has performed the manipulation to the information processing device,
the third control unit
receives the identification information transmitted by the first control unit, and
transmits an alert notification including the received identification information to the smart phone of the nurse, and
the second control unit
receives the alert notification transmitted by the third control unit, and
displays the received alert notification on the second display unit.
